(19) United States
(12) Patent Application Publication
(10) Pub. No.: US 2026/0099973 A1
(43) Pub. Date: Apr. 9, 2026

(54) ONE-SHOT COMPUTED TOMOGRAPHY RECONSTRUCTION USING INVERSE ABEL TRANSFORM

(71) Applicant: Lumafield, Inc., Cambridge, MA (US)

(72) Inventors: Adam P. Damiano, Somerville, MA (US); Andreas Linas Bastian, San Francisco, CA (US)

(21) Appl. No.: 19/351,862

(22) Filed: Oct. 7, 2025

Related U.S. Application Data
(60) Provisional application No. 63/704,357, filed on Oct. 7, 2024.

(51) Int. Cl. G06T 11/00; G01B 15/02; G01N 23/046; G01N 23/083; G06T 3/40; G06T 7/00; G06T 7/10; G06T 7/62; G06T 7/68

(52) U.S. Cl. CPC G06T 12/20; G01B 15/025; G01N 23/046; G01N 23/083; G06T 3/40; G06T 7/0004; G06T 7/10; G06T 7/62; G06T 7/68; G01N 2223/401; G01N 2223/611; G01N 2223/643; G06T 2207/10081; G06T 2207/30108; G06T 2207/30168

(57) ABSTRACT

Provided herein are methods, apparatuses, computer program products, and systems for one-shot computed tomography reconstruction using inverse Abel transform. One method can include obtaining a radiograph of at least one object using an X-ray scanner, wherein the at least one object has been manufactured using a manufacturing process; determining an axis of symmetry for at least a portion of the at least one object that is axisymmetric based on a type of the at least one object; generating a reconstruction image for the at least one object by applying an inverse Abel transform on the radiograph using the axis of symmetry; and providing an inspection result for the at least one object by processing the reconstruction image based on the type of the at least one object, wherein the inspection result causes a subsequent step of the manufacturing process to be performed based on the inspection result.

### CROSS-REFERENCE TO RELATED APPLICATIONS

This patent application claims priority to and the benefit of U.S. Provisional Patent Application No. 63/704,357, filed on Oct. 7, 2024, which is incorporated herein by reference in its entirety.

### BACKGROUND

X-ray devices use X-rays to create images of the inside of an object without disassembling the object. For example, an X-ray computed tomography (CT) scanner can be used by manufacturers to determine the quality of the products which they produce. X-ray devices are particularly useful to give manufacturers the ability to inspect certain parts of their products in a non-invasive, non-destructive fashion.

Two-dimensional (2D) X-ray scan data is used in part inspection in some industries. 2D X-ray scan data is faster to acquire than CT scan data, but does not provide full 3D information about the relative location of components or the densities of overlapping materials in the inspected parts. Three-dimensional (3D) scan data from a CT scan combines a series of X-ray projections taken from different projection angles and uses computer processing techniques to create a 3D reconstruction of the scan object. 3D CT scans provide more detailed information than 2D X-ray images. However, full CT scans typically require X-ray projections taken from a full 360 degrees rotation and typically take too long to be used in many production settings. Further, generating a CT reconstruction from a CT scan can require a large amount of computational resources.

Abel transform is an analytical method to project an axisymmetric emission function onto a line. Inverse Abel transform takes the projected function and reconstructs the emission function. In physics, the inverse Abel transform can be used in the study of combustion processes and absorption spectroscopy. The inverse Abel transform can be used in these applications because the experiments can be designed to have an axisymmetric emission function. However, in X-ray imaging, a scanned part is rarely to be perfectly axisymmetric, and the axisymmetric condition for applying the Abel transform and its inverse is violated.

Some systems (e.g., systems and techniques disclosed in U.S. patent application Ser. No. 20240273905A1) can perform categorical classification of objects in a solid waste stream using images generated by inverse Abel transform from 2D X-ray scans of the objects. However, these systems use segmentation among multiple unknown objects that may or may not meet the axisymmetric condition for use of the inverse Abel transform. Further, because these systems scan unknown objects with unknown or uncharacterized acquisition geometries, these systems are not expected to perform accurate quantitative measurement and qualitative characterization and are thus insufficient for the inspection needs for products produced in a manufacturing process.

### SUMMARY

This specification describes technologies relating to generating an approximate CT slice from a single radiograph of a manufactured object using inverse Abel transform, and performing quantitative measurement and qualitative characterization of the manufactured object for controlling the manufacturing process, failure analysis, or other applications.

Particular embodiments of the subject matter described in this specification can be implemented to realize one or more of the following advantages. The systems and techniques can be used to inspect products that have a high production rate because the systems and techniques can generate an image with CT scan quality from a one-shot 2D X-ray scan using inverse Abel transform. Rather than taking a CT scan to reveal the internal structure of a manufactured object, the systems and techniques take significantly less time to collect the scan data, and the reconstruction process is hundreds of times faster and requires significantly less memory and computation than reconstructing a CT volume.

Rather than scanning a heterogeneous mix of objects that may and may not meet the axisymmetric condition for use of the inverse Abel transform, the systems and objects can take advantage of known categories of objects to determine an axis of symmetry for a whole object or a portion of an object that is axisymmetric, and can generate a reconstruction image of the object by applying the inverse Abel transform using the determined axis of symmetry. Rather than limiting the inverse Abel transform to perfectly axisymmetric objects, the systems and techniques can apply the inverse Abel transform to a portion of an object that is locally axisymmetric even though the whole object is not perfectly axisymmetric.

Rather than simply generating a categorical classification of the whole object, the systems and techniques can generate an inspection result that includes accurate quantitative measurements and qualitative characterizations of products produced in a manufacturing process using known acquisition geometry of the X-ray scanner and known location and orientation of the scan objects. Although the inverse Abel transform assumes parallel X-rays and monochromatic X-ray spectrum, the systems and techniques can still use the inverse Abel transform for X-ray acquired using a fan-beam or a cone-beam X-ray source with a polychromatic X-ray spectrum. To compensate for inaccuracies resulting from these discrepancies, the systems and techniques can improve dimensional accuracy in the measurements through line-scan (e.g., for reducing parallax artifacts), scale correction, beam hardening correction, noise-reduction filters, or a combination of these.

The systems and techniques can use the inspection result for upstream and/or downstream intervention in manufacturing. For example, the system and techniques can change a manufacturing process parameter, such as providing feedback to a piece of equipment upstream of the X-ray scan inspection, in order to reduce the deviation of a quality metric. The systems and techniques can use the inspection result for sorting, binning, and grading of the manufactured products on a manufacturing line. For example, the systems and techniques can generate measurement of the anode-cathode overhang distances in battery cells and can use this measurement to adjust parameters in the upstream manufacturing process to minimize deviation from a target value. The systems and techniques described herein can provide advantages over other solutions because the systems and techniques can achieve many of the same measurement and inspection tasks that are traditionally only possible with computed tomography, but in a fraction of the required time. Thus, the systems and techniques can result in improved process control, increased sampling rates (e.g., the percentage of products that can be inspected), and improved product quality due to detecting and quarantining non-conforming products.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1A shows an example of a system that generates one-shot CT reconstruction using inverse Abel transform.

FIG. 1B shows an example of a local axisymmetric structure of a wound pouch cell battery.

FIG. 1C shows an example of a reconstruction image of a wound pouch cell.

FIG. 1D shows an example of a radiograph of a wound pouch cell.

FIG. 2 is a flowchart showing an example of a process to generate one-shot CT reconstruction using inverse Abel transform.

FIG. 3A shows an example of a radiograph of a battery.

FIG. 3B shows an example of a reconstruction image generated by applying inverse Abel transform to the radiograph in FIG. 3A.

FIG. 3C shows an example of a slice taken from a full CT scan of the battery.

FIG. 3D shows an example of measuring anode-cathode overhang distance using the reconstruction image in FIG. 3B.

FIGS. 3E, 3F, and 3G show an example of local axisymmetry in spiral structures.

FIG. 4A shows an example of a radiograph of an optical assembly.

FIG. 4B shows an example of a reconstruction image of the optical assembly.

FIG. 5A shows an example of a radiograph of a can.

FIG. 5B shows an example of a reconstruction image of the can.

FIG. 6A shows an example of a radiograph of a golf ball.

FIG. 6B shows an example of a reconstruction image of the golf ball.

FIG. 7A shows an example of a radiograph of an inhaler.

FIG. 7B shows an example of a reconstruction image of the inhaler.

FIG. 8A(1) shows an example of a radiograph of multiple objects.

FIG. 8A(2) is a flowchart showing an example of a process to generate reconstruction images for different portions of one object or multiple objects.

FIG. 8B shows an example of a cropped portion of the radiograph in FIG. 8A(1) that corresponds to a screwdriver.

FIG. 8C shows an example of a reconstruction image of the screwdriver.

FIG. 8D shows an example of a cropped portion of the radiograph in FIG. 8A(1) that corresponds to an extender.

FIG. 8E shows an example of a reconstruction image of the extender.

FIG. 8F shows an example of a cropped portion of the radiograph in FIG. 8A(1) that corresponds to a cylindrical deodorant stick.

FIG. 8G shows an example of a reconstruction image of the cylindrical deodorant stick.

FIGS. 9A-9D shows an example of tilted scans.

FIG. 10A shows an example of a radiograph of a lid of a coffee mug.

FIG. 10B shows an example of a reconstruction image of the lid.

FIG. 10C shows an example of a line-scan radiograph of the lid.

FIG. 10D shows an example of a reconstruction image of the lid generated from the line-scan radiograph in FIG. 10C.

FIG. 10E shows an example of generating the line-scan radiograph in FIG. 10C by combining rows of projection data generated by X-rays that are orthogonal to the axis of symmetry.

FIG. 11A shows an example of a system that generates a line-scan radiograph by translating the object.

FIG. 11B is a flowchart showing an example of a process to obtain a line-scan radiograph.

FIG. 12 is a flowchart showing an example of a process to identify and correct an artifact caused by an asymmetric feature of the object.

FIG. 13 is a flowchart showing an example of a process to perform scale correction.

FIG. 14 is a flowchart showing an example of a process to remove noise using a filter.

FIG. 15 is a flowchart showing an example of a process to determine substantial axisymmetry.

FIG. 16 is an example of a 2D slice of an object represented in a polar coordinate system.

FIG. 17 is an example of determining an angular step size for inspecting a seam of a container.

FIG. 18 is a flowchart showing an example of a process to determine substantial axisymmetry.

FIG. 19A is an example showing axisymmetric error for a cross section of a wound pouch cell battery.

FIG. 19B is an example showing an image of the cross section of the wound pouch cell battery overlaid with an isocontour.

Like reference numbers and designations in the various drawings indicate like elements.

### DETAILED DESCRIPTION

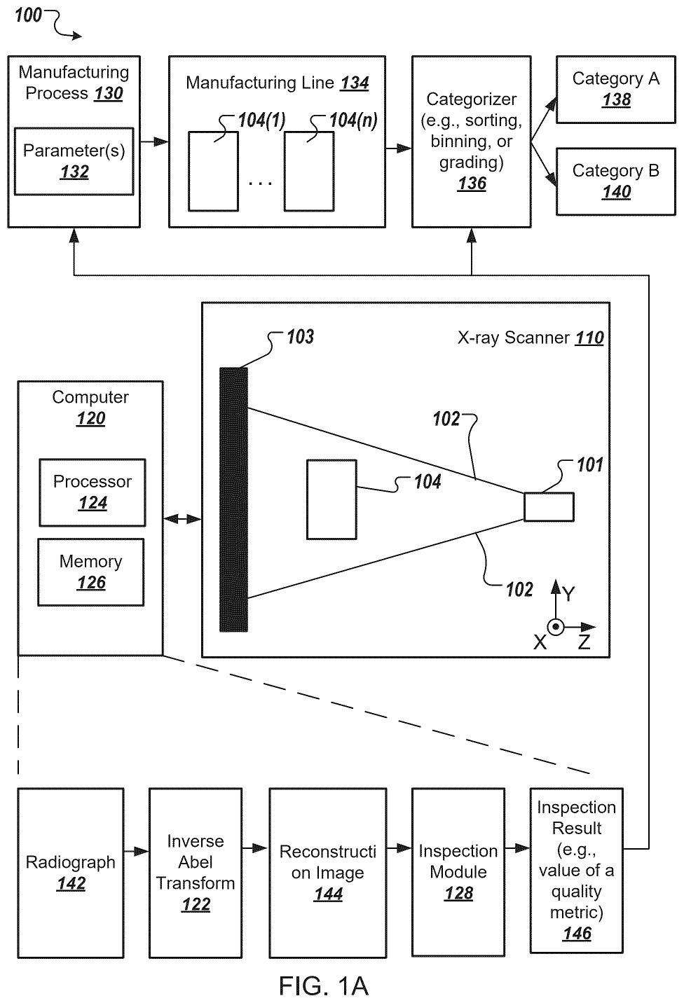

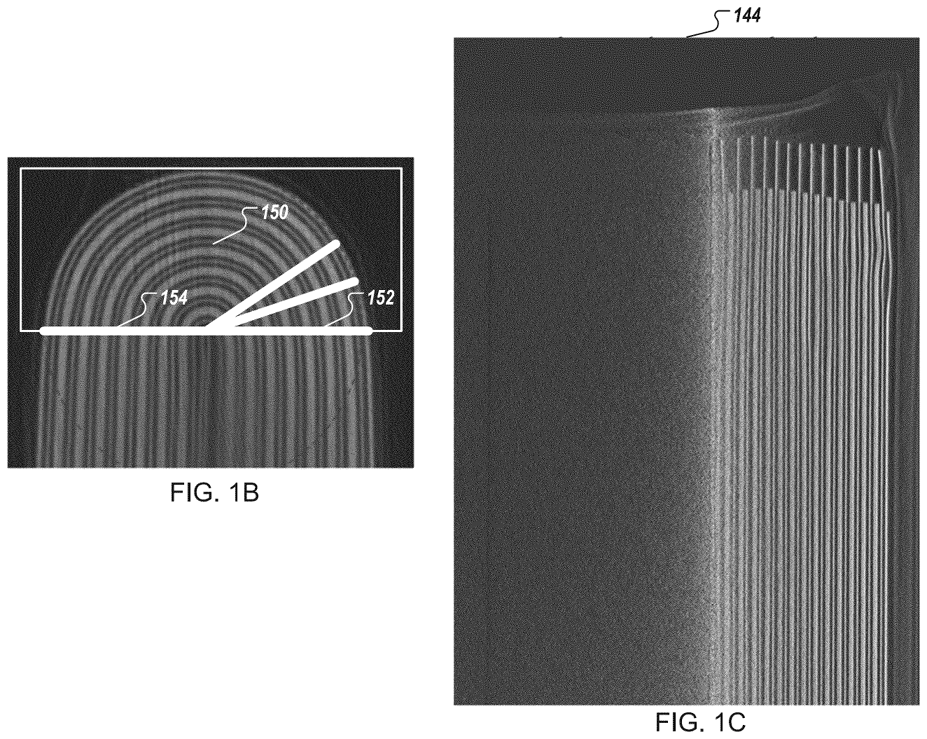

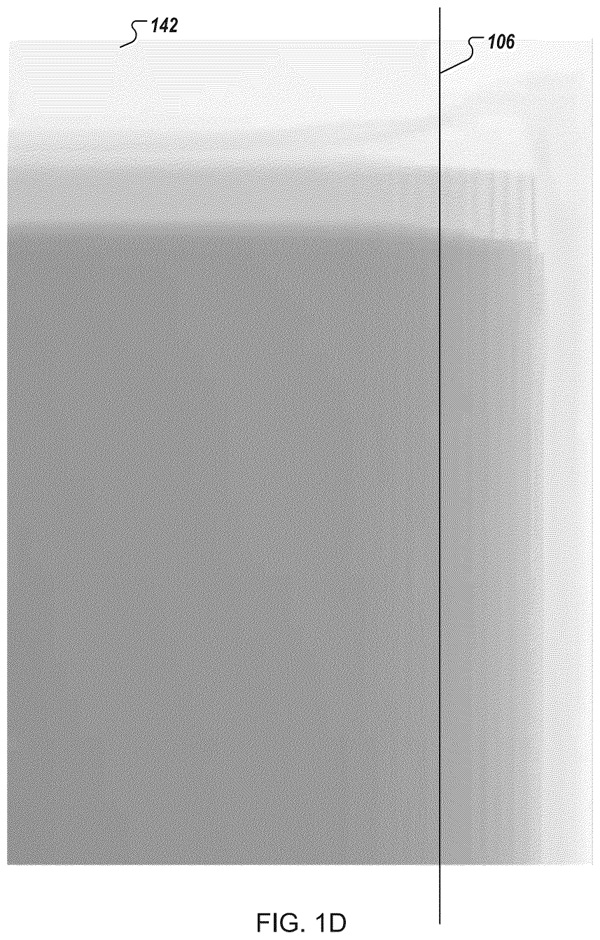

FIG. 1A shows an example of a system 100 that generates one-shot CT reconstruction using inverse Abel transform. The system 100 includes an X-ray scanner 110. The X-ray scanner 110 includes an X-ray source 101 configured to emit X-rays 102. The X-ray scanner 110 includes a detector 103 arranged to receive the X-rays 102 after interaction with an object 104 that has been placed in the X-ray scanner 110.

The object 104 has been manufactured using a manufacturing process 130. The manufacturing process 130 can generate a stream of objects 104(1) . . . 104(n) in a manufacturing line 134. In some implementations, the manufacturing line 134 can be a product handling line, such as a product packaging line, a product receiving line, or other kinds of product handling lines. In some implementations, the manufacturing line 134 can include a categorizer 136 that categorizes the objects 104 into different categories. For example, the categorizer 136 can sort, bin, or grade the objects into two or more categories, such as category A 138 and category B140.

The system 100 can use the X-ray scanner 110 to inspect the objects manufactured using the manufacturing process 130 at a high production rate. In some implementations, the X-ray scanner 110 can be next to the manufacturing line 134 to achieve inspection of products at the manufacturing line 134. For high throughput scanning, a common scanning configuration is to have a sequence of objects translated between an X-ray source and a detector via a conveyor system, e.g., a conveyer belt. This configuration improves throughput because the motion trajectory is simple, and the conveyor system can readily integrate into an existing production infrastructure. For example, the X-ray source 101 can be above the manufacturing line 134 and the X-ray detector can be below a conveyor belt of the manufacturing line 134. As each object 104 passes through the X-ray scanner 110 by the conveyor belt, the X-ray scanner 110 can obtain an X-ray scan of the object 104. In some implementations, the system 100 can move (e.g., using a mechanical arm or by a person) the object 104 away from the manufacturing line 134 and inside the X-ray scanner 110 for capturing the radiograph of the object 104. After the X-ray scanning is completed, the system 100 can move the object 104 back to the manufacturing line 134.

The object 104 or at least a portion of the object 104 is axisymmetric. An object is axisymmetric if it has an axis from which the object is the same in any direction. A portion of the object is axisymmetric if the portion of the object has an axis from which the portion of the object is the same in any direction. The axis is the axis of symmetry. A 3D axisymmetric object is rotationally symmetric about the axis of symmetry. For example, cylinders, cones, or spheres are examples of axisymmetric objects.

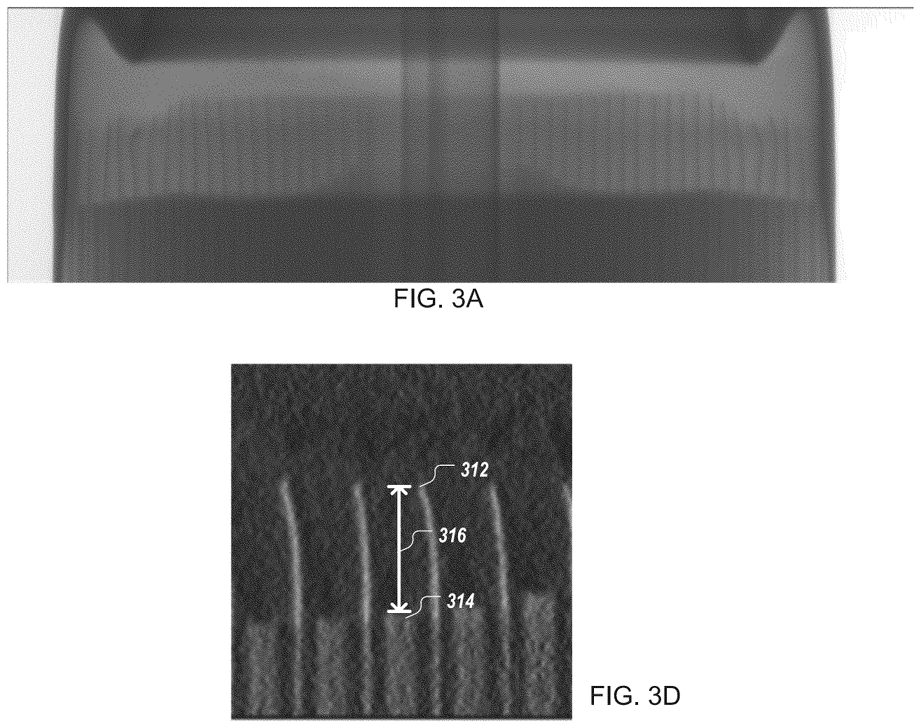

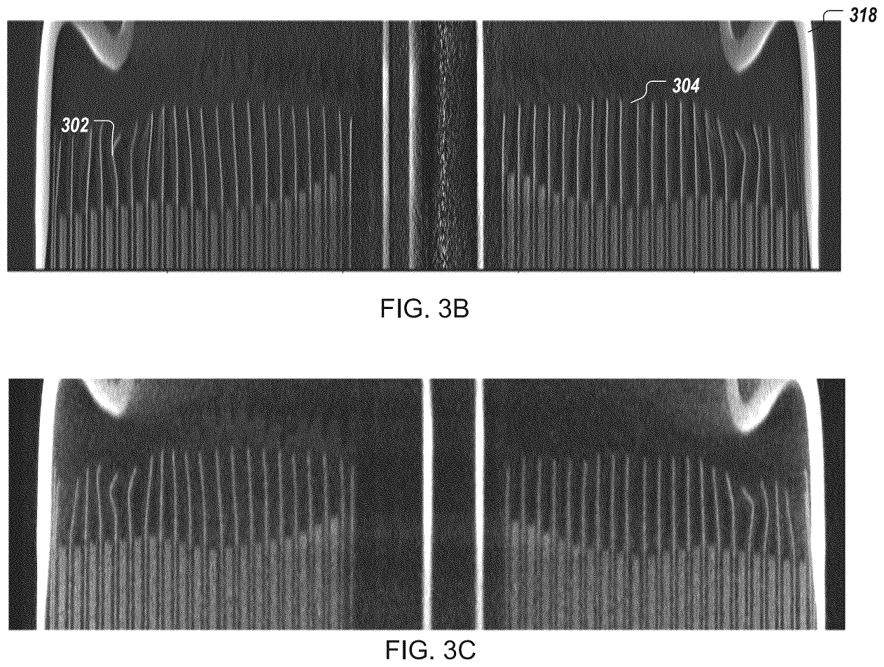

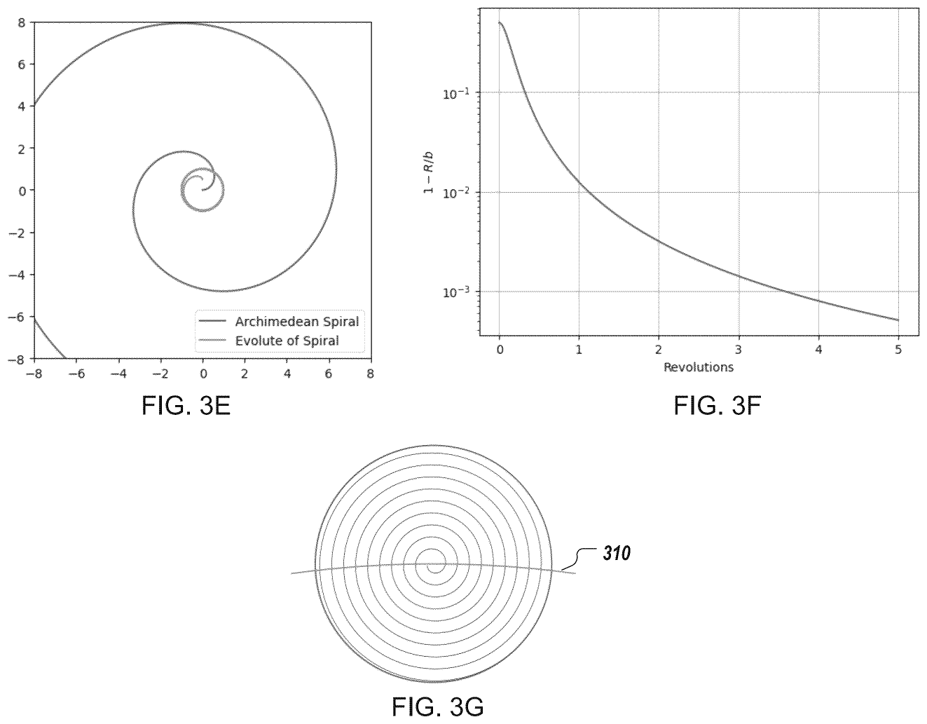

In some implementations, the system 100 can inspect partially or locally axisymmetric objects. That is, although an object itself is not completely axisymmetric, the system can still use the inverse Abel transform to generate a reconstruction image for a portion of the object that is axisymmetric. There are many products that are constructed from one or more layers of material that are coiled into a spiral. Some examples are capacitors, inductors, and air filters. An example for which there is significant inspection demand are Swiss roll style batteries, such as a lithium-ion 18650 cell. Because objects with spiral structure are locally axisymmetric, the system 100 can use the inverse Abel transform to generate a reconstruction image for the spiral portion of the object. More descriptions related to spiral structure in the object are described herein in connection with FIGS. 3E-3G.

FIG. 1B shows an example of a locally axisymmetric structure of a wound pouch cell battery. A wound pouch cell battery is a type of battery cell that is made by winding layers of cathode, anode, and separator together, and then sealing them in a flexible pouch. The wound pouch cell battery is mostly flat and has a U-turn shape at the end. FIG. 1C is a CT slice of a cross-sectional view of the internal layers of the wound pouch cell battery. Although the wound pouch cell battery is non-axisymmetric, a portion, e.g., the upper half 150, of the battery has a half circle shape and is locally axisymmetric.

The system 100 obtains a radiograph 142 of the object 104 using the X-ray scanner 110. For example, the system 100 can obtain a radiograph 142 of a wound pouch battery. FIG. 1D shows an example of a radiograph of a wound pouch cell. Rather than taking a full CT scan to reveal the internal structure of a manufactured object, the system 100 only takes a quick radiograph 142 of the object 104 using the 2D X-ray scanner 110, reducing the amount of time required to inspect each object in the manufacturing line. Thus, objects manufactured with a high production rate can be inspected with a higher inspection sampling rate than with a traditional CT scanner.

The system 100 obtains the type of the object. In some implementations, the system can receive product type information from the manufacturing system that implements the manufacturing process. In some implementations, the system can include a camera at the manufacturing line 134 or inside the X-ray scanner 110, and the system can obtain the type of the object based on a classification result generated from an image of the object captured by the camera. For example, the type of the object can be a battery, a bottle, a can, or a ball. Based on the type of the object 104, the system can determine an axis of symmetry 106 (shown in FIG. 1D) for at least a portion of the object in the radiograph 142. In some implementations, based on the type of the object 104, the system 100 can determine the type of inspection needed for properly inspecting the object. For example, because the system 100 knows that the object being scanned is a wound pouch cell that has locally axisymmetric structure towards the right end, the system 100 can determine the axis of symmetry 106 (shown in FIG. 1D) for the right portion of the battery in the radiograph 142.

The system 100 generates a reconstruction image 144 for the object 104 by applying an inverse Abel transform 122 on the radiograph 142 using the axis of symmetry 106. Because at least a portion of the object 104 is axisymmetric, the system 100 can generate a reconstruction image with CT scan quality from a one-shot 2D X-ray scan using inverse Abel transform. For example, the system 100 applies the inverse Abel transform to the radiograph 142 to generate a reconstruction image 144 of the object 104.

Abel transform is an analytical method to project an axisymmetric emission function onto a line. Inverse Abel transform takes the projected function and reconstructs the emission function. The inverse Abel transform can be implemented numerically in multiple ways, such as the Basis Set Expansion method, the onion peeling method, the three-point method, the two-point method, the direct method, and other appropriate methods. For example, the PyAbel library (https://pyabel.readthedocs.io/en/latest/transform_methods/comparison.html) provides a list of possible numerical methods to implement the inverse Abel transform.

FIG. 1C shows an example of a reconstruction image of a portion of a wound pouch cell battery, which is an enlarged image of the reconstruction image 144 in FIG. 1A. Because the wound pouch cell battery is locally axisymmetric, the system can generate a reconstruction image 144 for the local region of the battery. The reconstruction image 144 is an approximation to a CT slice with CT scan quality. The reconstruction image 144 can clearly show the wound layers in the battery and can be used to inspect salient features of the battery, such as anode-cathode overhang distances.

The system 100 provides an inspection result 146 for the object 104 by processing the reconstruction image 144 based on the type of the object. For example, because the system 100 knows that the object being inspected is a wound pouch cell battery, the system can provide an inspection result 146 of the battery that includes measurements of the anode-cathode overhang distances in the battery. In some implementations, the system 100 can use an inspection module 128 to process the reconstruction image 144 to generate the inspection result 146. In some implementations, the inspection result 146 can include quantitative measurements and qualitative characterizations of the object 104. Based on the type of the object and known acquisition geometry of the X-ray scanner 110, the inspection result 146 can include dimensionally accurate measurements, such as a value of a quality metric. Rather than relying on accurate alignment and segmentation algorithms, the system 100 can provide accurate dimensional measurements on the hardware/implementation side, e.g., based on known orientation of the object 104 in the X-ray scanner 110 and known geometry of the object 104.

In some implementations, the system 100, e.g., the inspection module 128, can perform anomaly detection, regressions, segmentations, and other 2D image analysis tasks such as blob detection, keypoint extraction, etc. The keypoint extraction, the regressions, the segmentations, etc., can be used for dimensional measurements and qualitative characterizations, e.g., for batteries.

For example, in battery inspection, the inspection result 146 can include a characterization of anodes and cathodes in the reconstruction image. For example, the system 100 can segment battery anodes from cathodes and can measure the distance between them. FIG. 3A shows an example of a radiograph of a battery. FIG. 3B shows an example of a reconstruction image generated by applying inverse Abel transform to the radiograph in FIG. 3A. FIG. 3D shows an example of measuring anode-cathode overhang distance using the reconstruction image in FIG. 3B. The system 100 can segment an anode 312 and a cathode 314 from the reconstruction image of the battery. The system 100 can measure the anode-cathode overhang distance 316 between the anode 312 and the cathode 314. In some implementations, the system 100 can measure an anode-cathode overhang distance between each pair of some or all of the neighboring anode-cathode pairs in the reconstruction image, and in some cases, can generate a combined anode-cathode overhang distance (e.g., an average anode-cathode overhang distance) over some or all of the neighboring anode-cathode pairs.

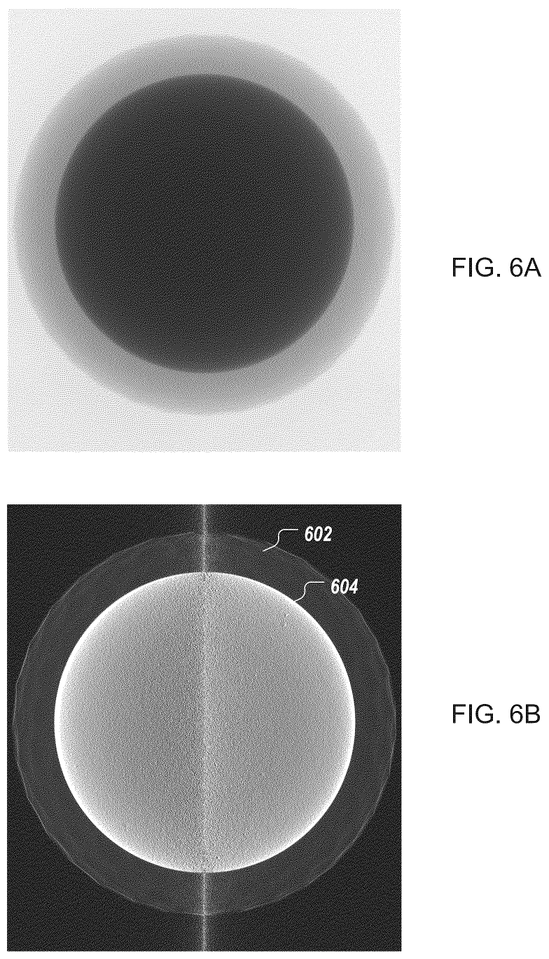

In some implementations, the system 100 can extract dimensions from internal structures and features in a product. FIG. 6A shows an example of a radiograph of a golf ball. FIG. 6B shows an example of a reconstruction image of the golf ball. For example, the system 100 can segment the reconstruction image of the golf ball and can extract measurements from the resulting boundaries.

The inspection result 146 can cause a subsequent step of the manufacturing process 130 to be performed based on the inspection result. The system 100 can cause upstream or downstream intervention(s) related to the manufacturing process 130. In some implementations, the system 100 can cause an update to a parameter 132 of the manufacturing process 130 based on the inspection result 146. The system can change a manufacturing process parameter 132 as a function of a measurement made from the reconstructed image 144. In some implementations, the system can provide feedback to a piece of equipment upstream of the X-ray inspection in order to reduce the deviation of a quality metric from a target value. For example, the system can update a manufacturing process parameter 132 used in manufacturing batteries in order to reduce the deviation of a quality metric, such as the anode-cathode overhang distance, from a set value.

In some implementations, the system 100 can provide the inspection result 146 to a categorizer 136 in the manufacturing line 134 and the categorizer 136 can sort, bin, or grade the objects 104(1)-104(n) based on the inspection result 146. For example, the categorizer 136 can sort the objects into category A 138 and category B140. The different categories can correspond to different quality levels, normal or abnormal, pass or fail. For example, the categorizer can sort, bin, group, or grade the batteries on the manufacturing line 134. Batteries that pass the inspection can be in the category A bin and batteries that do not pass the inspection can be in the category B bin.

The systems and techniques described herein can be used to inspect objects with a high production rate. For example, manufacturers of batteries can inspect most of all of the product in a production line that has a high production rate, at which traditional CT scan-based inspection can be applied. The system 100 can generate an approximate CT slice from a single radiograph. Compared to a traditional CT scan-based inspection, the systems and techniques can take less than 1% of the data collection to construct the reconstruction image, do not require a precision motion stage, and do not require advanced calibration of the scanner. The reconstruction process is hundreds of times faster and requires less than 1% of the memory requirements. Therefore, the systems and techniques can provide real-time inspection of manufactured products.

The system 100 includes a computer 120. The computer 120 can be one or more computers that are integrated with the X-ray scanner 110, and/or located remotely from the X-ray scanner 110 (e.g., at a remote server and communicatively coupled with the X-ray scanner 110, e.g., over the Internet). The computer 120 can include at least one processor 124. The processor(s) 124 can be embodied by any computational or data processing device, such as a central processing unit (CPU), application specific integrated circuit (ASIC), or comparable device. The processor(s) 124 can be implemented as a single controller, or a plurality of controllers or processors.

The computer 120 can include at least one memory 126. The memory 126 can be fixed or removable. The memory 126 can encode computer program instructions or computer code contained therein. Memory 126 can be any suitable storage device, such as a non-transitory computer-readable medium. The term “non-transitory,” as used herein, can correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory can be used. The one or more memories can be combined on a same integrated circuit as one or more processors, or can be separate from the one or more processors. Furthermore, the computer program instructions stored in the memory, and which can be run by the processor(s), can be any suitable form of computer program code, for example, a compiled or interpreted computer program written in any suitable programming language. In some implementations, the computer 120 can store 2D radiographs acquired by the X-ray scanner 110, reconstruction images generated from the 2D radiographs, inspection results, or a combination of these, in the memory 126.

The processor 124, the memory 126, and any subset thereof, can be configured to perform one or more processes including X-ray scanning and data acquisition, post-processing, generating the reconstruction images, and producing inspections results using the reconstruction images. The memory and the computer program instructions can be configured, with the processor for the particular device, to cause a hardware apparatus to perform one or more of the processes described in this application. Therefore, in some implementations, a non-transitory computer-readable medium is encoded with computer instructions that, when executed in hardware, perform a process such as one of the processes described herein. In some cases, one or more of the processes described herein are implemented entirely in hardware.

As noted above, in some implementations, these processes can be performed by the X-ray scanner 110, and so no separate computer is needed. In such implementations, the computer 120 and the X-ray scanner 110 are integrated into a single device, rather than being in separate devices as shown in FIG. 1A. In some implementations, the X-ray scanner 110 is an inexpensive scanning device with minimal processing capabilities, and a separate computer 120 is communicatively coupled with the X-ray scanner 110 and is configured to perform one or more of the processes described herein.

Although FIG. 1A is described in connection with the example of a wound pouch cell battery, the systems and techniques described herein are applicable to other types of batteries, such as cylindrical cells (e.g., common form factors, such as 18650, 21700, 4680, and chemistries such as lithium-ion, lithium iron phosphate, alkaline, etc.) and coin cells, and other types of objects that are axisymmetric or locally axisymmetric (at least in part).

FIG. 3A shows an example of a radiograph of a battery. For example, the image in FIG. 3A is a 24 second radiograph of a 18650 battery cell. FIG. 3B shows an example of a reconstruction image generated by applying inverse Abel transform to the radiograph in FIG. 3A. FIG. 3C shows an example of a slice taken from a full CT scan of the battery. For example, the slice in FIG. 3C is a slice taken from a reconstruction volume generated from a full CT scan and generating the reconstruction volume may take tens of minutes or several hours. As shown, the reconstruction image of FIG. 3B is actually better in regions of interest (e.g., at the anodes and cathodes of the battery) than the slice of the reconstruction volume of FIG. 3C despite taking much less time to produce.

The reconstruction image can be used for a wide variety of quality and manufacturing inspection tasks, such as measuring anode-cathode overhang distance, measuring can wall thickness of a wall 318, detecting bent or deformed electrodes (e.g., a bent electrode 302), measuring the fill level of electrolyte, detecting contaminant material, detecting a void, and detecting delaminations in the construction of the cell. FIG. 3D shows an example of measuring anode-cathode overhang distance 316 using the reconstruction image in FIG. 3B. In some implementations, the system can detect uneven anode-cathode overhang distance. For example, the system can detect that the anode-cathode overhang distances 304 on the right side of the reconstruction image in FIG. 3B is uneven.

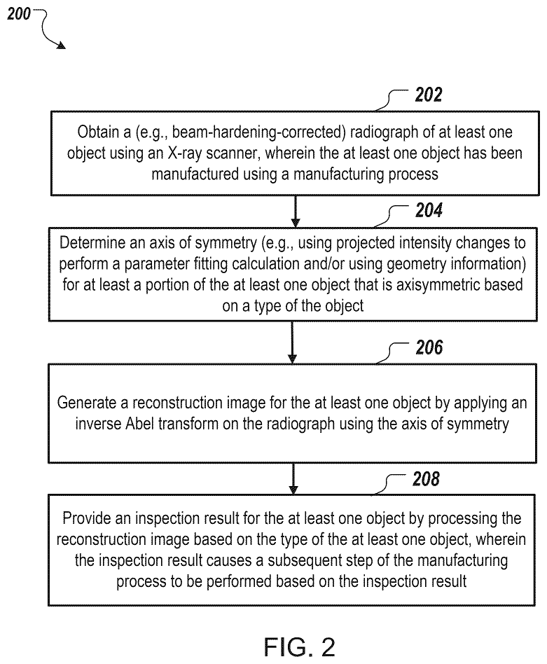

FIG. 2 is a flowchart showing an example of a process 200 to generate one-shot CT reconstruction using inverse Abel transform. For example, the system 100 can include (or be communicatively coupled with) a non-transitory computer-readable medium, e.g., the memory 126, encoding instructions configured to cause a processor, e.g., the processor 124, to perform the process 200 to generate one-shot CT reconstruction using inverse Abel transform. In some implementations, the process 200 can be performed in real-time on the X-ray scanner to achieve scanner-side inspection.

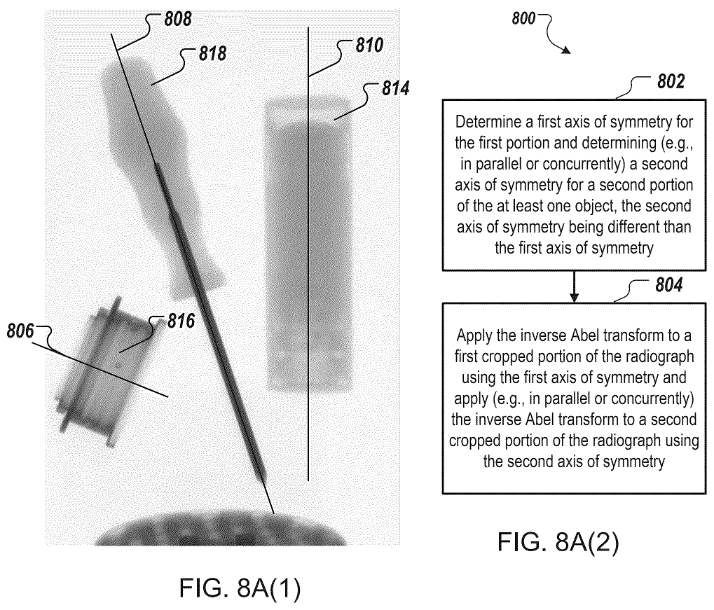

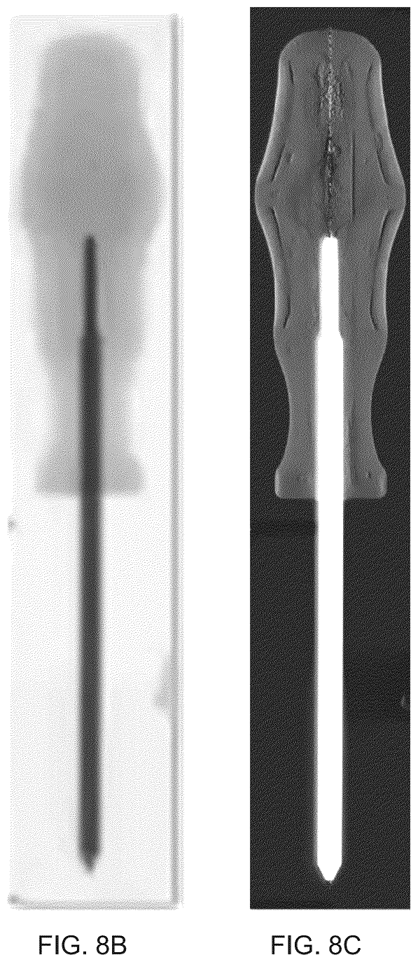

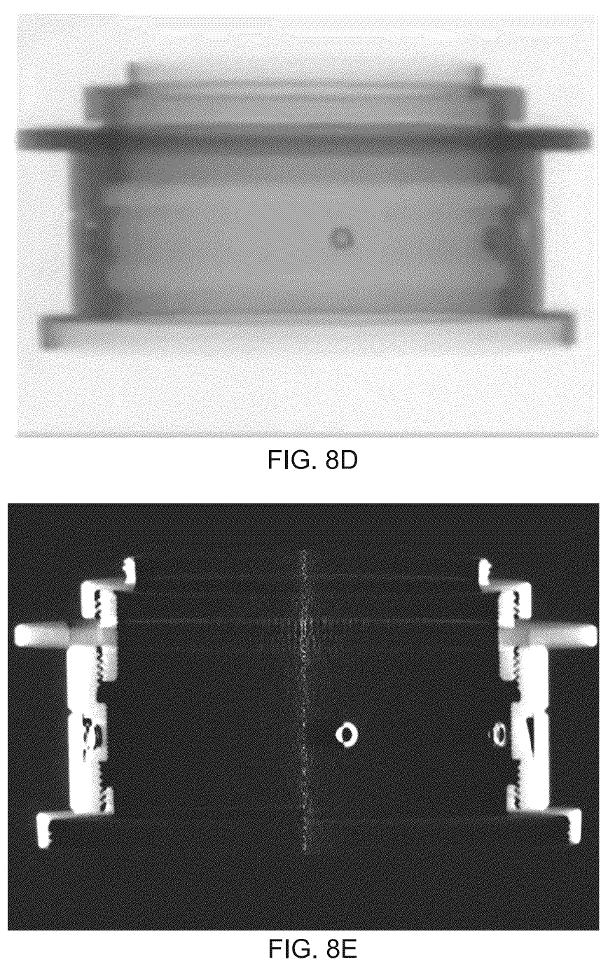

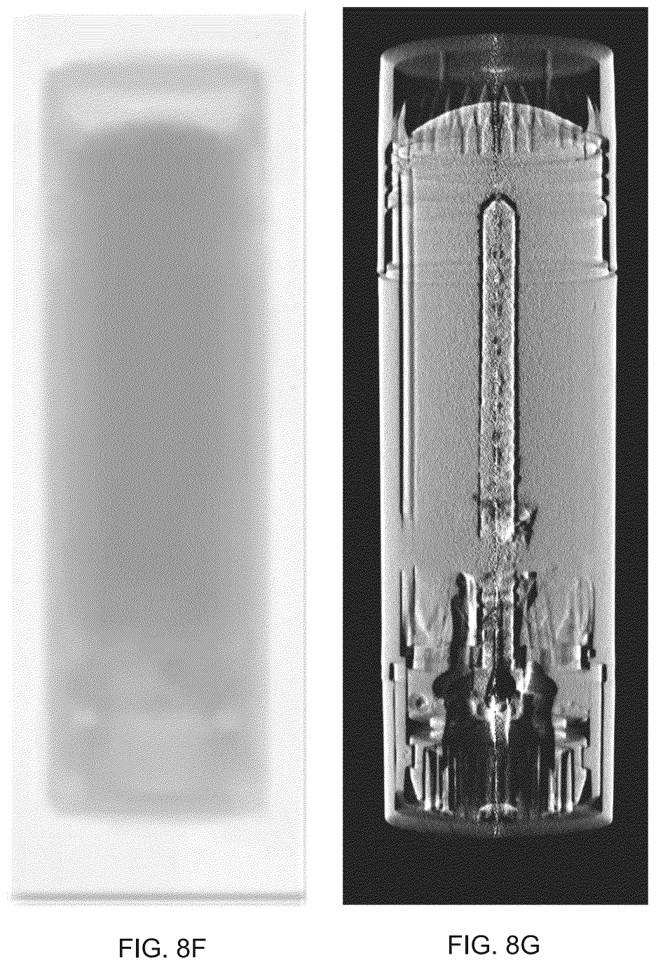

The system obtains (202) a radiograph of at least one object using an X-ray scanner, wherein the at least one object has been manufactured using a manufacturing process. In some implementations, the at least one object can be a single object. For example, in FIG. 1A, the system can obtain a radiograph of one battery at a time. In some implementations, the at least one object can include two or more objects. FIG. 8A(1) shows an example of a radiograph of multiple objects. The system can obtain a radiograph of three objects: a screwdriver 818, an extender 816, and a cylindrical deodorant stick 814.

In some implementations, X-rays of the X-ray scanner can be polychromatic. The radiograph can be a beam-hardening-corrected radiograph, and the obtaining (202) can include performing beam hardening correction on a received radiograph to obtain the beam-hardening-corrected radiograph. Beam hardening is the phenomenon that occurs when an X-ray beam of polychromatic energies passes through an object, resulting in selective attenuation of lower energy photons. As a result, only higher energy photons are left to contribute to the X-ray beam, and thus, the mean beam energy is increased (“hardened”). Beam hardening can cause the middle of the reconstruction image to decrease in value because the lower energy photons preferentially get attenuated over longer path lengths, leading to inaccuracies in the reconstruction image and the inspection result. The system can apply a beam hardening correction algorithm on the received radiograph. The beam hardening correction algorithm can adjust the intensity of the received radiograph, e.g., through a polynomial mapping, or a linearization method, to generate the beam-hardening-corrected radiograph.

The system determines (204) an axis of symmetry for at least a portion of the at least one object that is axisymmetric based on a type of the at least one object. For example, the type of the at least one object can be batteries, bottles, cans, or balls. In some implementations, based on the type of the at least one object, the system can obtain the known geometry of the object and can determine the axis of symmetry for the at least one portion of the at least one object based on the known geometry of the object.

In some implementations, at least a portion of the at least one object being axisymmetric can include at least a portion of the at least one object being substantially axisymmetric, meaning that the deviation from being a perfectly axisymmetric object is relatively small compared to the size (e.g., a diameter) of the object itself. The system can still apply the inverse Abel transform to the portion of the at least one object that is substantially axisymmetric to generate an approximate CT slice from a single radiograph.

In some implementations, the system can determine that at least the portion of the at least one object is substantially axisymmetric, such that the system can apply the inverse Abel transform to the portion of the at least one object that is substantially axisymmetric to generate an approximate CT slice from a single radiograph.

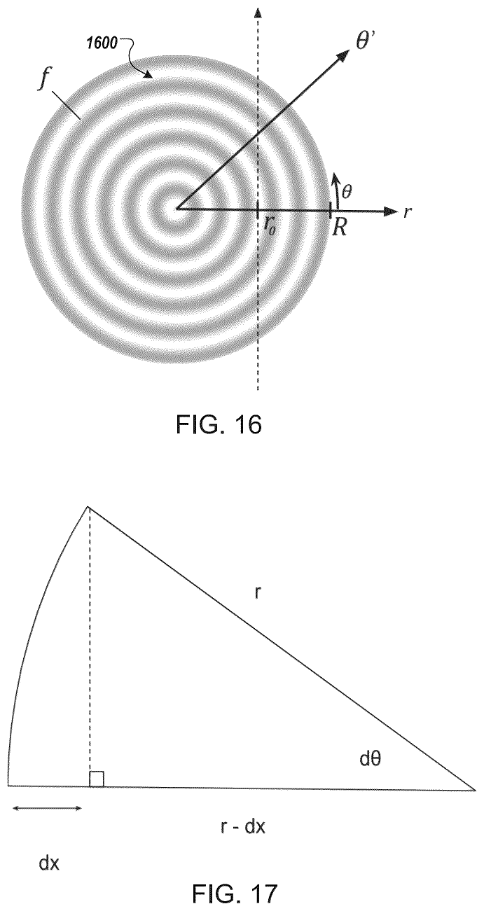

FIG. 16 is an example of a 2D slice 1600 of an object represented in a polar coordinate system. The 2D slice 1600 of is a cross section of an object. The 2D slice 1600 is represented in a polar coordinate system (r, θ). The cross section has an attenuation coefficient value, f, that is a function of radius, r, and angle, θ. For a true axisymmetric object, a gradient of the attenuation coefficient with regard to the angle equals to zero, i.e., df/dθ=0. However, the ideal case of true axisymmetry does not have to hold for diagnostically useful reconstruction using inverse Abel transform.

In some implementations, the system can obtain samplings of profiles of a 2D slice f(r, θ) of at least the portion of the at least one object at different values of angle θ. The system can determine whether the samplings of the profiles satisfy a similarity criterion, e.g., having a standard deviation that is less than a threshold. If the system determines that the samplings of the profiles satisfy the similarity criterion, the system can determine that the at least the portion of the at least one object is substantially axisymmetric. If the system determines that the samplings of the profiles does not satisfy the similarity criterion, the system can determine that the at least the portion of the at least one object is not substantially axisymmetric.

In some implementations, the system can determine whether at least the portion of the at least one object is substantially axisymmetric based on how information in the object non-uniformity contributes to the reconstruction image generated by applying the inverse Abel transform on the radiograph. FIG. 15 is a flowchart showing an example of a process 1500 to determine substantial axisymmetry.

In some implementations, the system can calculate (1502) an axisymmetric error in the at least one object using a similarity metric. In some implementations, the similarity metric can be based on a magnitude of a gradient of a 2D slice with respect to an angular coordinate of a polar coordinate system. The 2D slice is a cross section of the at least the portion of the at least one object, and the 2D slice is represented in the polar coordinate system, e.g., the polar coordinate system (r, θ) in FIG. 16.

For example, in FIG. 16, the system can determine an axisymmetric error at a reconstruction location in the object, f(r₀, 0). The information that contributed to the radiograph at r₀ is a function of the circular segment between θ=±cos⁻¹ (r₀/R). The similarity metric can be calculated over an area of the circular segment. When determining similarity between f(r, θ) and f(r, θ), the system can compare attenuation coefficient values of the object for r, wherein r₀/cos θ≤r≤R, and R is the maximum radius of the object.

The inverse Abel transform operates on the first derivative of the radiograph. An Abel transform of a gradient along r in the object contributes differently to the radiograph depending on the angle of the gradient with respect to the ray passing through the object. In the schematic representation in FIG. 16, a gradient change in the radiograph scales with the gradient change in the radius r of the reconstruction multiplied by the cosine of the angle, θ.

In some implementations, the similarity metric, G, at angle θ can be based on the magnitude of the gradient of the slice with respect to angle θ: |f_{θ}(r, θ)|. Because the similarity metric is computed over the circular segment between θ=±cos⁻¹(r₀/R), the similarity metric can be a sum of the magnitude of the gradient over the bounds of r₀/cos θ≤r≤R. In some implementations, the similarity metric can be the following:

$$G = {\int }_{{r}_{0} / cos θ}^{R} \vert {f}_{θ} ( r , θ ) \vert dr . \qquad ( 1 )$$

In some implementations, the similarity metric can be a weighted similarity metric, in order to take into consideration of the reduction in information contribution from slices further from θ=0. A slice is a planar cross section of the object across the axis of symmetry. For example, the similarity metric G′ can be formulated as a function of the angle θ, and can be the following:

$${G}^{′} = cos θ {\int }_{{r}_{0} / cos θ}^{R} \vert {f}_{θ} ( r , θ ) \vert dr \qquad ( 2 )$$

In some implementations, the system can compute the axisymmetric error by integrating the similarity metric over contributing slices to generate a sum, and average this sum with the area of the circular segment. For example, the maximum slice angle Θ that contributes to the reconstruction can be

$$θ = {cos}^{- 1} \frac{{r}_{0}}{R} .$$

Because the geometry is symmetrical about the r-axis, the system can integrate over the range −Θ≤θ≤Θ. The axisymmetric error E can be the following:

$$E = \frac{1}{A} {\int }_{- Θ}^{Θ} {G}^{′} d θ \qquad ( 3 )$$

Here, A is the area of the circular segment. In some implementations, the system can compute A using the following:

$$A = \frac{{R}^{2}}{2} ( 2 Θ - sin ( 2 Θ ) ) .$$

Therefore, the axisymmetric error E evaluated at a radius r₀ can be the following:

$$E ( {r}_{0} ) = \frac{2}{{R}^{2} ( 2 Θ - sin ( 2 Θ ) )} {\int }_{- Θ}^{Θ} cos θ {\int }_{{r}_{0} / cos θ}^{R} \vert {f}_{θ} ( r , θ ) \vert dr d θ \qquad ( 4 )$$

Here, the maximum slice angle

$$Θ = {cos}^{- 1} \frac{{r}_{0}}{R} .$$

In some implementations, the system can determine (1504) whether the axisymmetric error is less than a threshold value. In some implementations, in response to determining that the axisymmetric error is less than the threshold value, the system can determine (1506) that at least the portion of the at least one object is substantially axisymmetric. In some implementations, in response to determining that the axisymmetric error is not less than the threshold value, the system can determine (1508) that at least the portion of the at least one object is not substantially axisymmetric.

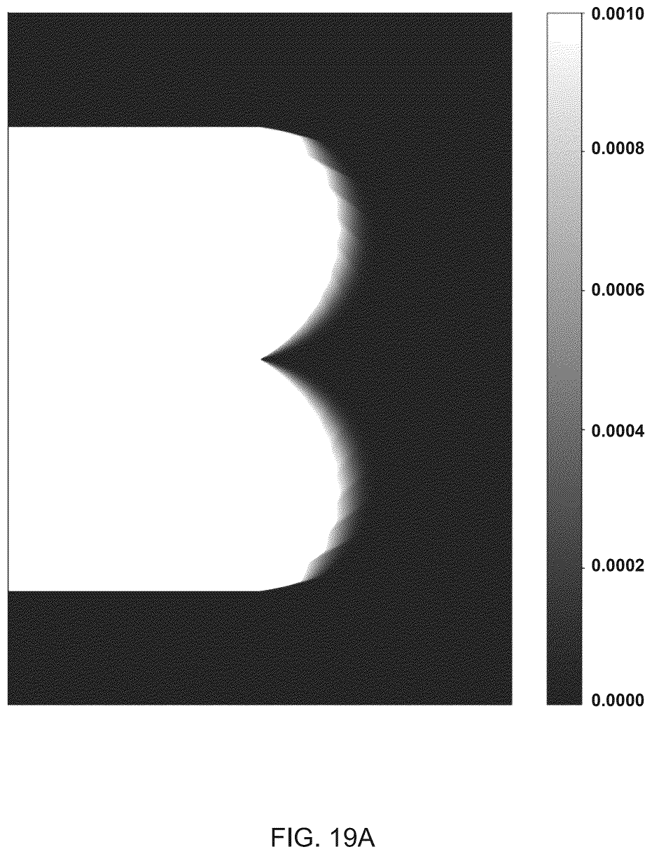

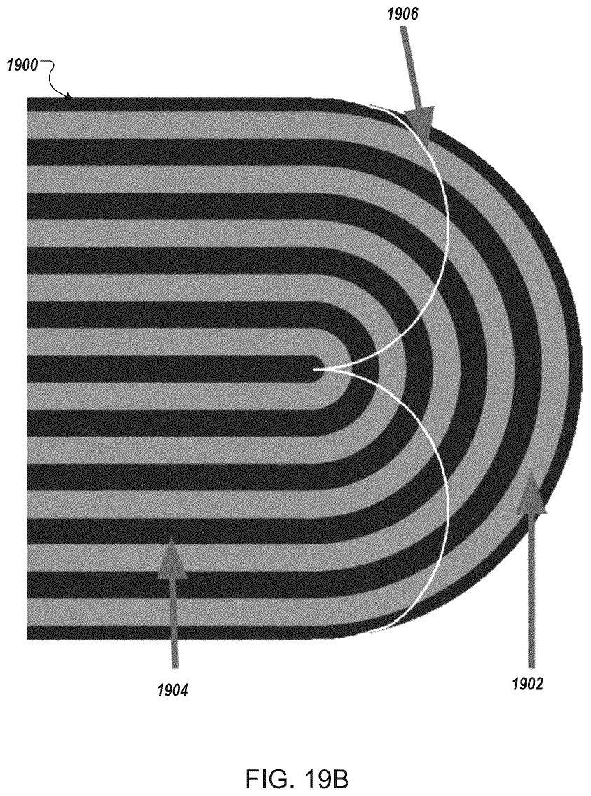

FIG. 19A is an example showing axisymmetric error for a cross section of a wound pouch cell battery, e.g., similar to the wound pouch cell battery in FIG. 1B. The darker pixels correspond to smaller axisymmetric errors and the brighter pixels correspond to larger axisymmetric errors. The system can determine whether the axisymmetric error for the cross section is less than a threshold value, e.g., 0.0001. FIG. 19B is an example showing an image 1900 of the cross section of the wound pouch cell battery overlaid with an isocontour 1906. The isocontour 1906 is the white line where the axisymmetric error (shown in FIG. 19A) is 0.0001. The system can determine the portion 1902 of the cross section of the battery that the axisymmetric error is less than 0.0001. The system can determine that the portion 1902 (e.g., the region on the right side of the isocontour 1906) is substantially axisymmetric and can be reconstructed using the inverse Abel transform. The system can determine the portion 1904 (e.g., the region on the left side of the isocontour 1906) of the cross section of the battery that the axisymmetric error is not less than 0.0001. The system can determine that the portion 1904 is not substantially axisymmetric and cannot be reconstructed using the inverse Abel transform.

In some implementations, the threshold value can be application dependent. In some implementations, the threshold value can be empirically determined based on a type of inspection for the at least one object. For example, the system can determine the threshold value by comparing CT scans and reconstructions generated by the inverse Abel transform. The system can determine the maximum axisymmetric error required based on a result of comparing the CT scans and the reconstructions.

In some implementations, the at least one object or the portion of the at least one object can be elliptically symmetric along a major axis and a minor axis. The system can generate (1501) a scaled object by scaling the at least one object along the major axis or the minor axis such that after the scaling, the at least one object or the portion of the at least one object have the same size along the major axis and the minor axis. The system can determine that the scaled object is substantially axisymmetric, e.g., using a process like the process 1500 or the process 1800, such that the system can apply the inverse Abel transform to scaled object that is substantially axisymmetric to generate an approximate CT slice for the scaled object from a single radiograph.

For example, the at least one object can be an elliptically symmetric object. The system can scale the object along the major axis such that at least one object has the same size along the major axis and the minor axis. The system can determine whether the scaled object is substantially axisymmetric using the process 1500 or the process 1800.

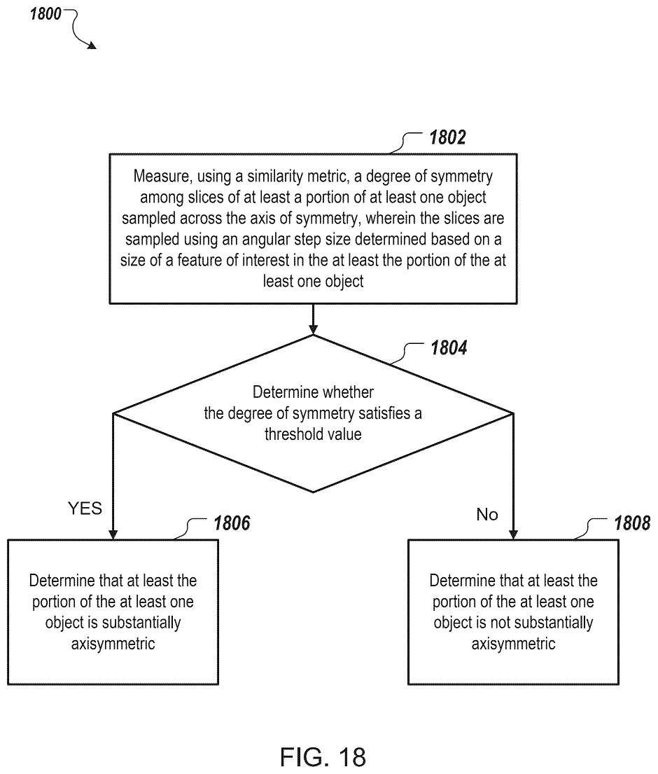

In some implementations, the system can determine whether at least the portion of the at least one object is substantially axisymmetric by measuring the degree of symmetry of the portion of the object across the axis of symmetry. FIG. 18 is a flowchart showing an example of a process to determine substantial axisymmetry.

In some implementations, the system can measure (1802), using a similarity metric, a degree of symmetry among slices of the at least the portion of the at least one object. The slices can be sampled across the axis of symmetry using an angular step size. The angular step size is the angle between two neighboring slices sampled across the axis of symmetry. For example, referring to FIG. 1B, the system can sample across the axis of symmetry of a wound pouch cell battery. The system can sample from a starting angle 152 (e.g., θ=0) to an ending angle 154 (e.g., θ=180) using the angular step size dθ=1. Thus, the system can obtain 181 slices. The system can compute the degree of similarity among the 181 slices.

In some implementations, the angular step size can be determined based on a size of a feature of interest in the at least the portion of the at least one object. In some implementations, the system can choose an angular step size such that the arc length at the maximum radius of a reconstruction field of view is about equivalent to the size of the feature of interest in the reconstructed slice.

FIG. 17 is an example of determining an angular step size for inspecting a seam of a container. The feature of interest is the seam of the container. The radius r of the can is 25 mm in radius. The size of the feature of interest, e.g., the seam, is 0.05 mm. The system can choose an angular step size to make sure that variations of the feature of interest can be represented in the angular slices. For example, in FIG. 17, the system can choose the angular step size de to make sure that the seam of size dx=0.05 mm can be represented in the angular slices. Because

$$cos ( d θ ) = \frac{r - dx}{r} ,$$

the angular step size dθ can be calculated using the following:

$$d θ = arccos ( \frac{r - dx}{4} ) .$$

In the example in FIG. 17, the

$$d θ = arccos ( \frac{25 - 0.05}{0.05} ) \approx 3.6 degrees .$$

In some implementations, the similarity metric can include one or more of: pixel-wise mean squared error (MSE), peak signal-to-noise ratio (PSNR), or cross-correlation. In some implementations, the similarity metric can include MSE. The system can measure pixel-wise MSE values among the slices sampled across the axis of symmetry. For example, the system can measure MSE values between adjacent slices θᵢ₋₁ and θᵢ. Other measures are possible. A low MSE value can indicate high local axisymmetry, and a high MSE value can indicate poor local axisymmetry.

In some implementations, the similarity metric can include cross-correlation, which can be a bounded and/or normalized metric. The system can measure cross-correlation values between the slices sampled across the axis of symmetry. For example, the system can measure cross-correlation values between adjacent slices θᵢ₋₁ and θᵢ. Other measures are possible. A high cross-correlation value can indicate high local axisymmetry, and a low cross-correlation value can indicate poor local axisymmetry.

In some implementations, the system can compute raw degree of symmetry values (e.g., MSE or cross-correlation values) and can compute a rolling average of the raw values using a window size. A rolling average (also called a moving average) calculates the average of a set of data points over a defined window. A rolling average can be used to smooth out fluctuations and noise in data, making it easier to identify underlying trends and improve forecasting. For example, the window size can be 3, 5, or 10. By using the rolling average, the system can reduce the impact of noise on the measures of the degree of symmetry.

In some implementations, the system can use denoising techniques to reduce the impact of noise on the measurements for the degree of symmetry. In some implementations, the system can apply a denoising algorithm on the at least the portion of the at least one object. The system can measure the degree of symmetry across slices of the denoised object. Examples of the denoising algorithm include algorithms using spatial filters (e.g., mean, Gaussian, median, or bilateral filters), deep learning based denoising using a trained neural network model, or any appropriate denoising techniques.

In some implementations, the system can determine (1804) whether the degree of symmetry satisfies a threshold value. In some implementations, in response to determining that the degree of symmetry satisfies the threshold value, the system can determine (1806) that at least the portion of the at least one object is substantially axisymmetric. In some implementations, in response to determining that the degree of symmetry does not satisfy the threshold value, the system can determine (1808) that at least the portion of the at least one object is not substantially axisymmetric.

In some implementations, the similarity metric can include MSE. The system can determine whether MSE values between the slices samples across the axis of symmetry satisfy a threshold value. For example, the system can determine whether the rolling average of the MSE values stays below the threshold value. In response to determining that the MSE values satisfy the threshold value, the system can determine that the at least the portion of the at least one object is substantially axisymmetric. In response to determining that the MSE values do not satisfy the threshold value, the system can determine that the at least the portion of the at least one object is not substantially axisymmetric.

In some implementations, the similarity metric can include cross-correlation. The system can determine whether cross-correlation values between the slices samples across the axis of symmetry satisfy a threshold value. For example, the system can determine whether the rolling average of the cross-correlation values stays above the threshold value. In response to determining that the cross-correlation values satisfy threshold value, the system can determine that the at least the portion of the at least one object is substantially axisymmetric. In response to determining that the cross-correlation values do not satisfy the threshold value, the system can determine that the at least the portion of the at least one object is not substantially axisymmetric.

In some implementations, the threshold value can be a predetermined value. For example, the predetermined value for a similarity metric using rolling average cross-correlation can be 0.9, 0.91, or 0.92. The system can determine the threshold value by measuring the degree of symmetry of an axisymmetric object (e.g., a fully axisymmetric object) using the similarity metric. For example, the system can obtain a CT scan of a cylindrical cell battery. The system can measure the MSE values or the cross-correlation values for slices sampled across the axis of symmetry of the cylindrical cell battery. The system can determine the maximum MSE value or the minimum cross-correlation value. The system can determine the threshold value based on the maximum MSE value or the minimum cross-correlation value. For example, the minimum cross-correlation value for the fully axisymmetric cylindrical cell battery is 0.93. Based on that, the system can determine that the threshold value is 0.92.

In some implementations, the object can include one or more layers of a material arranged in a spiral shape, and the object is substantially axisymmetric. The system can still apply the inverse Abel transform to the object with spiral internal shape to generate an approximate CT slice from a single radiograph. The effectiveness of this approximation can be validated as follows.

FIGS. 3E, 3F, and 3G show an example of local axisymmetry in spiral structures. Consider the evolute of an Archimedean spiral defined by the expression r=b\theta (the evolute of a curve is the locus of all of its centers of curvature). While the evolute initially starts near the origin at a radius of b/2, the evolution quickly converges to a circle of radius b, shown in FIG. 3E for a spiral of b=1. The convergence is quick and within 2 revolutions, and the deviation of the evolute radius from b is less than 0.3%, see FIG. 3F. Therefore, the instantaneous center of the Archimedean spiral is contained within a circle of radius b. Also note that b is equal to the layer thickness divided by 2pi. Therefore, in the case of an 18650 battery with 350 micron pitch between layers, b is ˜56 microns, so the deviation from a circle can be considered small with respect to the battery diameter itself, over 320 times larger. Furthermore, while the evolution of the full spiral traces a circle, the portions of the evolution that correspond to the slice of the battery being inferred, take up just a small arc of the circle. For example, consider a battery of 18 mm diameter being scanned 80 mm from the focal spot. The slice that is created by this method corresponds to the line 310 in FIG. 3G. In FIG. 3G, the X-ray focal spot is at (0, −80). In this example, the projected instantaneous center of the spiral intersecting this slice is contained within a range from 0 to 0.12b. Therefore, despite the spiral nature of the underlying emission field, the instantaneous center of the reconstructed data varies by less than 6.7 microns. In some implementations, the system can identify a start and an end of the spiral and can deliberately orient one or both of the start and end of the spiral to align with the axis of symmetry of the object to reduce artifacts associated with asymmetry at the start and/or end of the spiral.

In some implementations, determining the axis of symmetry can include using geometry information of the at least one object to predict the axis of symmetry. The system can use known object geometry to predict and/or refine the axis of symmetry. For example, the system can use a feature of the object (e.g., a housing of the object or one or more layers of the object) to identify the axis of symmetry. In some implementations, determining the axis of symmetry can include using projected intensity changes in the radiograph to perform a parameter fitting calculation to predict the axis of symmetry. The system can use projected intensity changes to predict and/or refine the axis of symmetry. In some implementations, the system can determine the axis of symmetry using an algorithm that identifies an axis of symmetry, such as algorithms based on phase correction, feature point matching, Gestalt algebra, and other appropriate methods.

For example, if the object is approximately a solid axisymmetric object of a constant material, the projected intensity changes in the radiograph are a function of distance from the axis of symmetry. The projected intensity changes can be proportional to 2\sqrt{R²−y²} where R is the distance from the axis of symmetry to where the object stops, and y is the distance from the axis of symmetry. The system can determine R by solving for the parameters of best fit. Based on the value for R, the system can determine the axis of symmetry. As another example, if the object has a geometry similar to a thin wall, the projected intensity changes in the radiograph can be a curve of

$$\frac{R}{\sqrt{{R}^{2} - {y}^{2}}} .$$

The system can determine the axis of symmetry by solving for the parameters of best fit for R. As another example, the system can use a modulation transfer function of the anode-to-background transition in the reconstruction image to identify when the anodes are the sharpest, and use this information to determine the axis of symmetry.

In some implementations, the system can perform an offset scanning, in which the center of the object and the imaging center of the X-ray scanner are offset from each other. Offset scanning allows more magnification and allows scanning over a wider area than normal scanning. The system can use offset scanning to inspect large or small objects without the need for a larger X-ray scanner. Although it can be challenging to identify the location of the axis of symmetry in offset scanning, the system can use the techniques described above (e.g., using projected intensity changes in the radiograph and the geometry information of the at least one object to perform a parameter fitting calculation) to determine the axis of symmetry.

Referring back to FIG. 2, the system generates (206) a reconstruction image for the at least one object by applying an inverse Abel transform on the radiograph using the axis of symmetry. In some implementations, the system can determine different axes of rotation for different portions of one object or multiple objects. In some implementations, the different portions can be different portions of one object. For example, if an object has multiple axisymmetric portions with different axes of symmetry, the system can perform reconstruction for the different portions. In some implementations, the at least one object can include a first object and a second object, which are not connected with each other in the radiograph.

FIG. 8A(2) is a flowchart showing an example of a process 800 to generate reconstruction images for different portions of one object or multiple objects.

In some implementations, the at least the portion of the at least one object can include a first portion of the at least one object. The determining can include determining (802) a first axis of symmetry for the first portion and determining (802) a second axis of symmetry for a second portion of the at least one object. The second axis of symmetry is different than the first axis of symmetry. The generating can include applying (804) the inverse Abel transform to a first cropped portion of the radiograph using the first axis of symmetry and applying (804) the inverse Abel transform to a second cropped portion of the radiograph using the second axis of symmetry.

In some implementations, the determining (802) for the first axis and the determining (802) for the second axis can be performed in parallel or concurrently. In some implementations, the applying (804) the inverse Abel transform to the first cropped portion of the radiograph and the applying (804) the inverse Abel transform to the second cropped portion of the radiograph can be performed in parallel or concurrently. For example, two or more processors of one or more computers (e.g., the computer 120) can perform the processing steps for the multiple objects at the same time simultaneously, or at overlapping time periods.

In some implementations, the at least one object can include a first object and a second object, which are not connected with each other in the radiograph. The first portion can be in the first object, and the second portion can be in the second object.

FIG. 8A(1) shows an example of a radiograph of multiple objects. The system can obtain a radiograph of three objects: a screwdriver 818, an extender 816, and a cylindrical deodorant stick 814. The system can determine an axis of symmetry for each object. For example, the system can determine the axis of symmetry 806 for the extender 816, the axis of symmetry 808 for the screwdriver 818, and the axis of symmetry 810 for the cylindrical deodorant stick 814. The system can use the techniques described herein to determine the axis of symmetry for each object. In some implementations, the system can segment the radiograph into multiple (cropped) portions for the multiple objects. The system can determine the axis of symmetry for each object in the cropped portion of the object.

The system can generate a reconstruction image for each object by applying the inverse Abel transform to each cropped portion for each object. FIG. 8B shows an example of a cropped portion of the radiograph in FIG. 8A(1) that corresponds to a screwdriver. FIG. 8C shows an example of a reconstruction image of the screwdriver. FIG. 8D shows an example of a cropped portion of the radiograph in FIG. 8A(1) that corresponds to an extender. FIG. 8E shows an example of a reconstruction image of the extender. FIG. 8F shows an example of a cropped portion of the radiograph in FIG. 8A(1) that corresponds to a cylindrical deodorant stick. FIG. 8G shows an example of a reconstruction image of the cylindrical deodorant stick.

In some implementations, the system can improve dimensional accuracy in the vertical direction (e.g., the Y direction of the X-ray scanner 110 in FIG. 1A) and reduce parallax artifacts by capturing data in a line-scan fashion. The parallax artifacts in an X-ray scanner occur when an X-ray beam diverges from an X-ray source of the scanner, distorting the size and position of structures of the object in the X-ray image. When the X-ray source of the X-ray scanner generates a cone-shaped or a fan-shaped X-ray beam, the reconstruction image can have parallax artifacts for a portion of the at least one object that is not close to the plane that is orthogonal to the axis of symmetry and intersects the X-ray source (e.g., the X-ray focal spot).

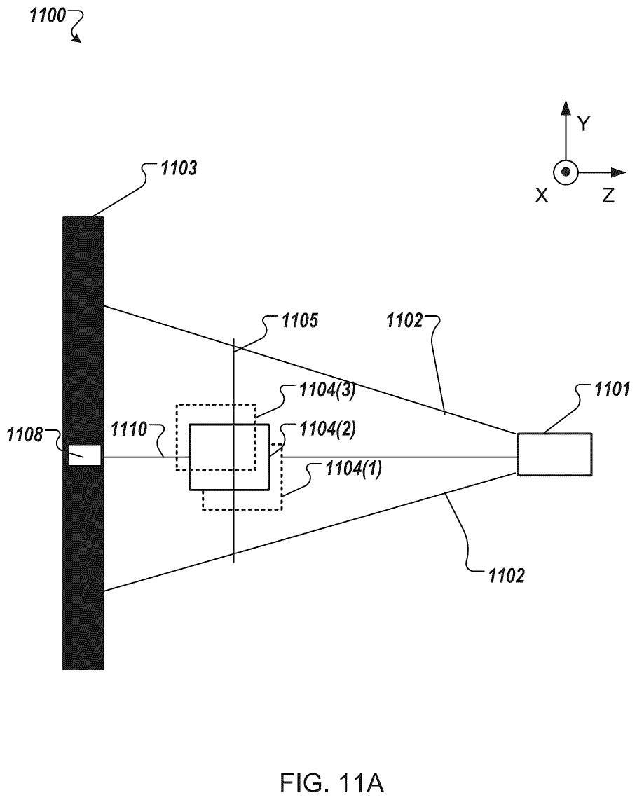

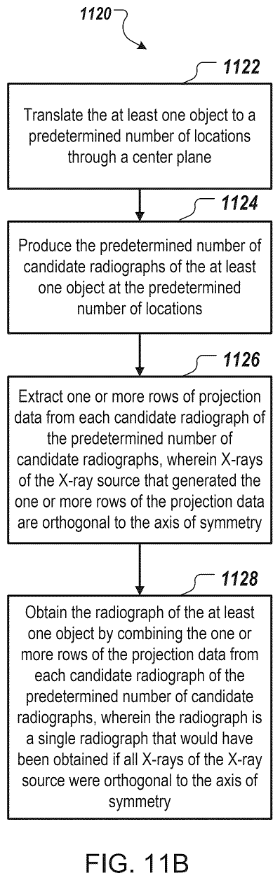

FIG. 11A shows an example of a system 1100 that generates a line-scan radiograph by translating the object. Without the line-scan, the system scans the object at a single location, e.g., the location 1104(2) of the object. The axis of symmetry of the object at the object location 1104(2) is the axis 1105. The X-ray source is 1101 and the X-ray source generates a cone-shaped (e.g., a fan shaped beam in both the Y-Z plane and the X-Y plane) or a fan-shaped X-ray beam (e.g., a fan shaped beam in the Y-Z plane). The center plane is the plane 1110 that is orthogonal to the axis of symmetry 1105 and intersects the X-ray source 1101. The X-ray beam 1102 diverges from the X-ray source 1101. The X-rays that go through or near the center plane 1110 arrive at one or more rows 1108 of the detector 1103. For the portions of the object that are not close to the center plane 1110, the size and position of the structures may be inaccurate. For the portions of the object that are very close to or at the center plane 1110, the size and position of the structures characterized in the projection data at the one or more rows 1108 of the detector are more accurate.

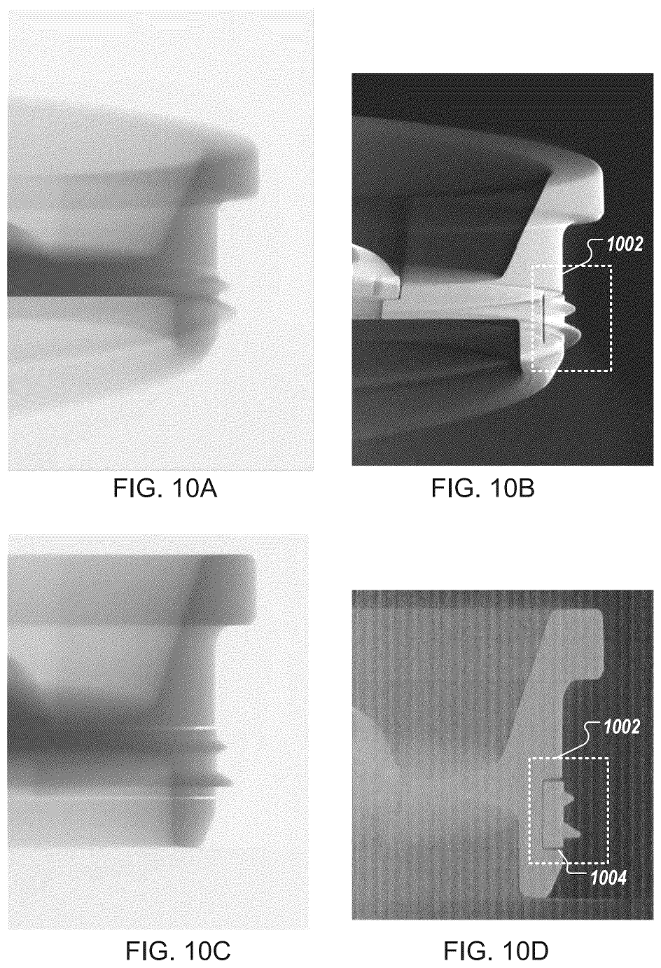

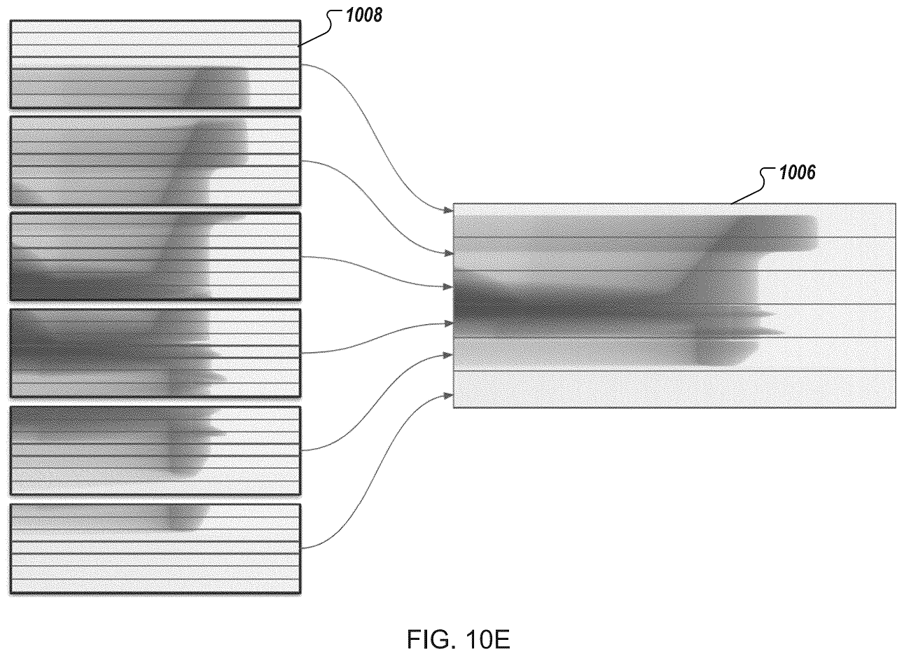

FIG. 10A shows an example of a radiograph of a lid of a coffee mug. FIG. 10B shows an example of a reconstruction image of the lid generated from the radiograph in FIG. 10A. The lid has a plastic seal 1002 that can be used to prevent the coffee mug from leaking. Because of the divergent X-rays, the reconstruction image in FIG. 10B does not have an accurate dimension representation of the structure of the seal, e.g., especially the top and bottom of the seal.

In some implementations, the system can reduce the parallax artifacts by keeping the regions of interest near the center plane. For example, the system can generate a more accurate reconstruction image of the seal 1002 by placing the seal 1002 of the lid near the center plane 1110 of the X-ray scanner in the system 1100.

In some implementations, the system can obtain radiographs in a line-scan fashion, in which the object can be translated through the center plane and projection data of the radiographs that are close or at the center plane can be combined together to generate a combined radiograph. The system can generate a reconstruction image from the combined radiograph and the reconstruction image generated from the combined radiograph can have improved dimensional accuracy.

FIG. 11B is a flowchart showing an example of a process 1120 to obtain a line-scan radiograph. The system can translate (1122) the at least one object to a predetermined number of locations through a center plane. The predetermined number is greater than one. The center plane is a plane that is orthogonal to the axis of symmetry and intersects the X-ray source of the X-ray scanner. For example, referring to the system 1100 in FIG. 11A, the system can translate the object to several locations 1104(1), 1104(2), and 1104(3) of the object, through the center plane 1110. In some implementations, the system can translate the object along a direction that is parallel to the axis of symmetry 1105 of the object. In some implementations, the system can translate the object along a direction that is not parallel to the axis of symmetry 1105.

The system can produce (1124) the predetermined number of candidate radiographs of the at least one object at the predetermined number of locations. For example, at each location of the object locations 1104(1), 1104(2), and 1104(3), the system can produce a corresponding candidate radiograph of the object. The system can extract (1126) one or more rows of projection data from each candidate radiograph of the predetermined number of candidate radiographs. X-rays of the X-ray source that generated the one or more rows of the projection data are orthogonal to the axis of symmetry. In some implementations, the system can determine how many rows of the projection data from the detector can be used. The number of rows can be a function of the geometry of the object and the inspection task. In some implementations, the system can determine the number of rows based on how much the projection distortion affects the inspection task.

For example, the system can extract a row 1108 of the projection data from the candidate radiograph of the object location 1104(1), and the row 1108 of the projection data can correspond to the upper portion of the object that is scanned with non-divergent X-rays. Similarly, the system can extract a row 1108 of the projection data from the candidate radiograph of the object location 1104(2) that corresponds to the middle portion of the object that is scanned with non-divergent X-rays, and the system can extract a row 1108 of the projection data from the candidate radiograph of the object location 1104(3) that corresponds to the bottom portion of the object that is scanned with non-divergent X-rays.

The system can obtain (1128) the radiograph of the at least one object by combining the one or more rows of the projection data from each candidate radiograph of the predetermined number of candidate radiographs. The radiograph is a single radiograph that would have been obtained if all X-rays of the X-ray source were orthogonal to the axis of symmetry. That is, the radiograph does not have distortion effects in the vertical direction (e.g., Y direction of the X-ray scanner 110 in FIG. 1A or the system 1100 in FIG. 11A). For example, the system can generate a radiograph by stitching or stacking together, row by row, the three rows of the projection data for the object at the three locations 1104(1), 1104(2), and 1104(3). The system can generate a reconstruction image by applying the inverse Abel transform as described herein.

FIG. 10C shows an example of a line-scan radiograph of the lid. FIG. 10D shows an example of a reconstruction image of the lid generated from the line-scan radiograph in FIG. 10C. The system can move the lid vertically up and take samples of rows. The system can generate the radiograph in FIG. 10C by stitching together rows of candidate radiographs of the lid that is translated up. The radiograph in FIG. 10C is produced with X-rays that are non-divergent in the vertical direction, e.g., the Y direction of the X-ray scanner 110 in FIG. 1A. FIG. 10E shows an example of generating the line-scan radiograph in FIG. 10C by combining rows of projection data generated by X-rays that are orthogonal to the axis of symmetry. The system can obtain six candidate radiographs of the lid that is translated up. From each candidate radiograph, the system can obtain seven rows of projection data that are orthogonal to the axis of symmetry of the lid. For example, the system can obtain seven rows of projection data 1008 from the first candidate radiograph for the topmost portion of the lid and the seven rows of projection data 1008 are generated by X-rays that are orthogonal to the axis of symmetry of the lid. The system can stitch together the rows of the candidate radiographs to generate the radiograph 1006 (the radiograph in FIG. 10C). In some cases, the X-rays may still be divergent horizontally, e.g., in the X direction in the X-ray scanner 110 in FIG. 1A. The system can generate the reconstruction image in FIG. 10D, which is a more dimensionally accurate image than the reconstruction image in FIG. 10B. For example, the gap 1004 at the top and bottom, and around the seal 1002 is visible.

In some implementations, the system can improve dimensional accuracy in the horizontal direction (e.g., the X direction in the X-ray scanner 110 in FIG. 1A) by scale correction. In some implementations, the X-rays can be divergent when an X-ray source of the X-ray scanner generates a cone-shaped or a fan-shaped X-ray beam. Because the inverse Abel transform assumes parallel X-rays, the physical sizes for the pixels in the horizontal direction (e.g., the X direction in the X-ray scanner 110 in FIG. 1A) are not uniform.

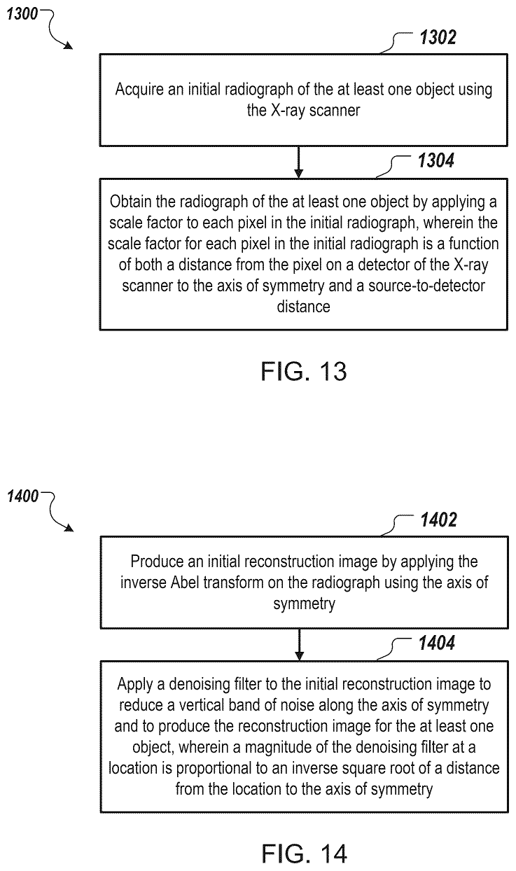

The system can apply a scale factor to each pixel for improved dimensional accuracy in the horizontal direction. FIG. 13 is a flowchart showing an example of a process 1300 to perform scale correction. The system can acquire (1302) an initial radiograph of the at least one object using the X-ray scanner. The system can obtain (1304) the radiograph of the at least one object by applying a scale factor to each pixel in the initial radiograph. The scale factor for each pixel in the initial radiograph is a function of both a distance from the pixel on a detector of the X-ray scanner to the axis of symmetry and a source-to-detector distance.

For example, the system can first calculate a nominal pixel size for each pixel of the object by dividing the pixel size by a magnification factor of the object. The magnification factor is the source-to-detector distance (SDD) divided by the source-to-axis-of-symmetry distance. Next, for each pixel, the system can calculate a scale factor and can multiply the nominal pixel size of each pixel to the scale factor. The scale factor is

$$\frac{1}{\frac{{x}^{2}}{{SDD}^{2}} + 1} ,$$

where x is the distance from the pixel on the detector to the axis of symmetry. After applying the magnification factor and the scale factor, the pixel sizes in the radiograph can be non-uniform in the horizontal dimension. The system can calculate a dimensional measurement or generate a reconstruction image based on the unequal sizes of the pixels in the radiograph. For example, measurements can reference the unequal step sizes, and the reconstruction slice can be resampled to have equal pixel sizes.

In some implementations, the system can tilt an object toward and/or away from an X-ray source to resolve threads. In some implementations, the at least one object can include threads, and the system can place the object in a position such that the threads can be parallel with X-rays of the X-ray scanner that intersect with the threads. For example, threads of a bottle can be better resolved by tilting the bottle so that the threads are aligned to be parallel with the rays traveling from the X-ray source. In some implementations, the system can first tilt the object towards the X-ray source to resolve one side of threads, and the system can next tilt the object away from the X-ray source to resolve the other side of threads.

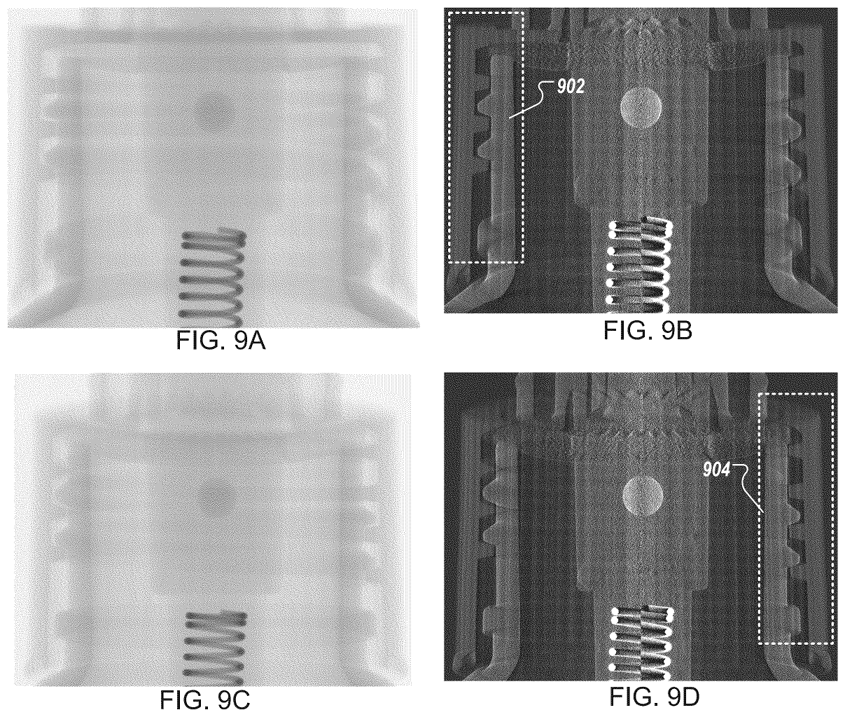

FIGS. 9A-9D shows an example of tilted scans. FIG. 9A shows an example of a radiograph of a bottle tilted towards the X-ray source so that the threads 902 on the left are approximately parallel with the X-rays. FIG. 9B shows an example of a reconstruction image of the bottle generated from the radiograph in FIG. 9A. The threads 902 on the left are well represented in the reconstruction image in FIG. 9B because the threads 902 on the left are approximately parallel with the X-rays. FIG. 9C shows an example of a radiograph of the bottle in FIG. 9A tilted away from the X-ray source so that the threads 904 on the right are approximately parallel with the X-rays. FIG. 9D shows an example of a reconstruction image of the bottle generated from the radiograph in FIG. 9C. The threads 904 on the right are well represented in the reconstruction image in FIG. 9D because the threads 904 on the right are approximately parallel with the X-rays.

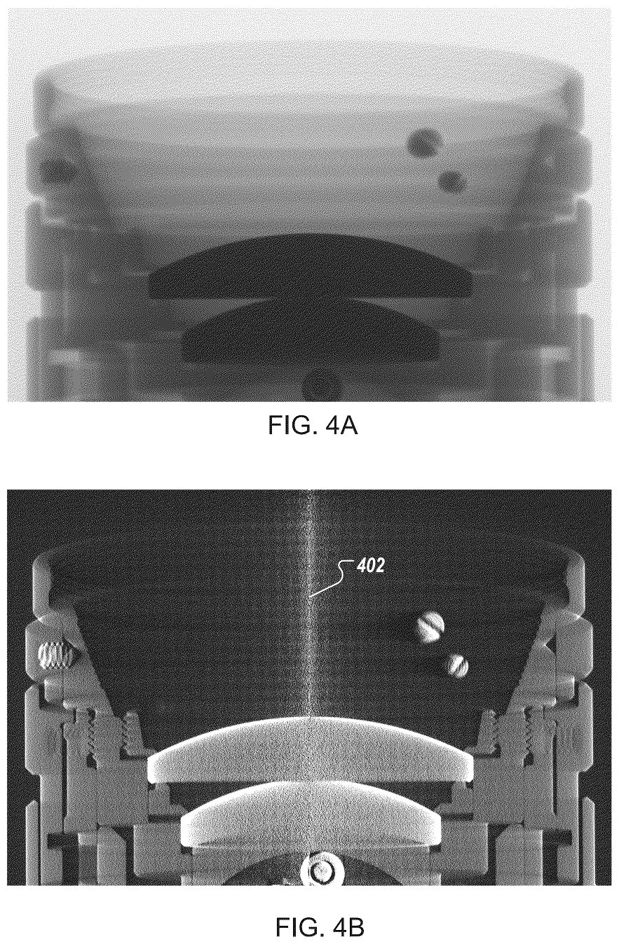

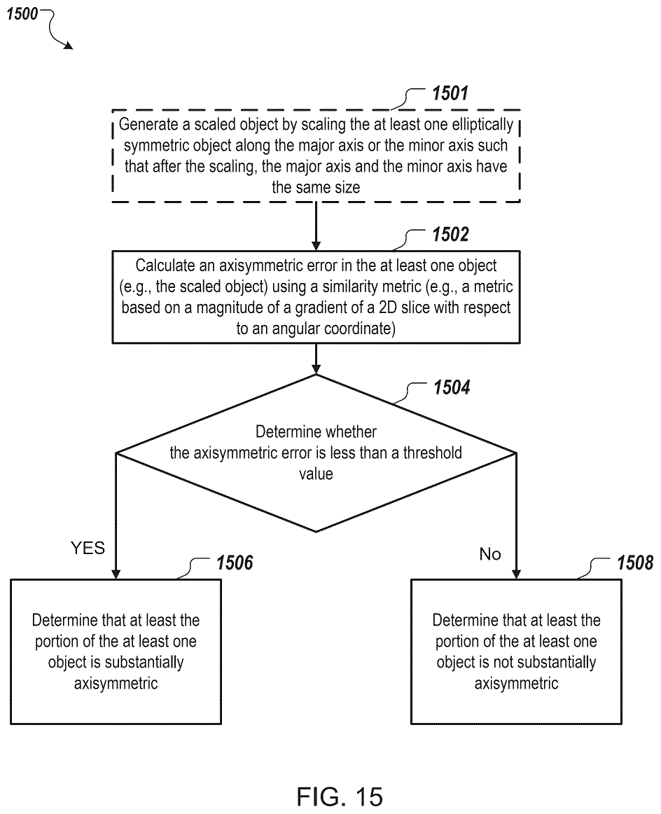

In some cases, the reconstruction image can have a vertical line (e.g., a band) of noise. The noise in the radiograph includes pixel intensity values that are not precisely representative of the object scanned by the X-ray scanner. The process of performing the inverse Abel transform to generate the reconstruction image amplifies noise of the pixels that are near the axis of symmetry in the radiograph and results in the vertical line of noise in the reconstruction image. The intensity of the noise at a pixel location can be proportional to an inverse of a square root of a distance from the axis of rotation to the pixel location. For example, FIG. 4B shows an example of a reconstruction image of an optical assembly. The reconstruction image in FIG. 4B has a vertical line of noise 402. The intensity of the noise band is larger near the axis of rotation and is smaller away from the axis of rotation. In some implementations, the system can remove the vertical line of noise in the reconstruction image using a filter. FIG. 14 is a flowchart showing an example of a process 1400 to remove noise using a filter. The system can produce (1402) an initial reconstruction image by applying the inverse Abel transform on the radiograph using the axis of symmetry. The system can apply (1404) a denoising filter to the initial reconstruction image to reduce a vertical band of noise along the axis of symmetry and to produce the reconstruction image for the at least one object. A magnitude of the denoising filter at a location can be proportional to an inverse square root of a distance from the location to the axis of symmetry. In some implementations, the system can use a band-stop filter (e.g., a black band filter) to suppress regions in a reconstruction image where the contrast to noise ratio is below a threshold and the regions in the reconstruction image cannot be used for inspection purposes.

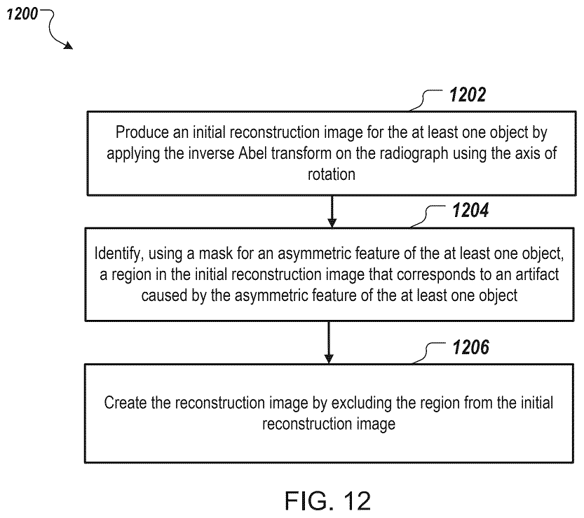

FIG. 12 is a flowchart showing an example of a process 1200 to identify and correct an artifact caused by an asymmetric feature of the object. The system can identify a reconstruction error caused by an asymmetric feature or features that are geometrically present in the region represented by the reconstructed image, but present as artifacts due to their violation of the assumptions of the inverse Abel transform. For example, the current interrupt device (CID) in cylindrical battery cells breaks the axisymmetric approximation and results in an artifact in an inverse Abel reconstructed image. In packaging applications, certain flexures or closures can produce artifacts as can the tops of bottoms of bottles and tubes that experience projection distortion.

The system can produce (1202) an initial reconstruction image for the at least one object by applying the inverse Abel transform on the radiograph using the axis of rotation. The system can identify (1204), using a mask for an asymmetric feature of the at least one object, a region in the initial reconstruction image that corresponds to an artifact caused by the asymmetric feature of the at least one object. For example, the system can use a mask derived from a prior CT scan of the object to obtain a region of the reconstruction image that likely corresponds to the feature. In some implementations, the mask can be a manually generated mask for the asymmetric feature. The system can create (1206) the reconstruction image by excluding the region from the initial reconstruction image. For example, the system can exclude the regions of the image that contain artifacts.

For example, in consumer packaged goods and packaging applications, it is often important to measure the wall thickness of bottles and tubes. In some cases, projection distortion from a cone beam system will result in artifacts in the reconstruction image that do not accurately reflect the true structure of the imaged object. Using a prior CT scan of the object, the system can obtain a mask for an asymmetric feature of the object that is likely going to cause artifacts. The system can crop out these projection artifacts using the mask generated from the prior CT scan of the object. Applying this masking process, the system can improve the automatability and the accuracy of subsequent inspection tasks, such as wall thickness measurements.

Referring back to FIG. 2, the system provides (208) an inspection result for the at least one object by processing the reconstruction image based on the type of the at least one object, wherein the inspection result causes a subsequent step of the manufacturing process to be performed based on the inspection result. The subsequent step of the manufacturing process can include one or more upstream interventions and/or one or more downstream interventions in manufacturing. In some implementations, the system generates the inspection result, e.g., using the inspection module 128 in FIG. 1A. For example, the inspection module 128 of the system 100 can process the reconstruction image based on the type of the at least one object to provide the inspection result 146, e.g., a value of a quality metric. In some implementations, the system can provide the reconstruction image to another device or another computer that processes the reconstruction image to generate the inspection result. In some implementations, the inspection result can be generated with traditional image analysis methods (e.g., edge detection, blob detector, and feature extractors), one or more machine learning models, or a combination of both.

In some implementations, the subsequent step of the manufacturing process can include updating a parameter of the manufacturing process. The inspection result can cause a parameter of the manufacturing process to be updated based on the inspection result. In some implementations, the inspection result can include a value of a quality metric of the manufacturing process based on the reconstruction image, and the inspection result can cause the parameter of the manufacturing process to be updated in order to reduce a deviation of the quality metric from a predetermined value.

In some implementations, the subsequent step of the manufacturing process can include categorizing the at least one object, e.g., using a categorizer 136. In some implementations, the inspection result can cause categorizing the at least one object on a manufacturing line based on the inspection result. The categorizing can be sorting, binning, grading, or a combination of these.

In some implementations, the system can provide an inspection result in battery applications. In some implementations, the at least one object can include a battery, and the providing can include inspecting the battery using the reconstruction image to provide the inspection result. In some implementations, the inspection can include measuring an anode-cathode overhang distance of the battery using the reconstruction image, measuring a uniformity of layers of the battery using the reconstruction image, detecting contaminant materials or a void within layers of the battery using the reconstruction image, measuring a thickness of a can wall of the battery using the reconstruction image, measuring an electrolyte fill level of the battery using the reconstruction image, or a combination of these. For example, the system can measure the uniformity of the layers of the battery to detect any swelling or warping in the battery, which can indicate pressure-build up or mechanical damages in the battery. As another example, the system can detect voids or gaps within the layers of the battery which can lead to degraded performance of the battery.

In some implementations, the system can extract a feature from the reconstruction image. The feature can include one or more key points, one or more blobs, or both, generated using an image analysis algorithm. The system can generate a dimensional measurement of an object, (e.g., a battery, a bottle, or a ball), using the feature extracted from the reconstruction image. The inspection result can include the dimensional measurement of the object that indicates a quality of the object.

In some implementations, the system can generate a segmentation for the reconstruction image. The system can generate a characteristic of an object, (e.g., a battery, a bottle, or a ball) using the segmentation for the reconstruction image, wherein the inspection result can include the characteristic of the object that indicates a quality of the object. In some implementations, the characteristic can include a distance between structures, a measurement of an area or a volume, a presence of an inclusion or a void, or a combination of these. For example, rather than performing a simple classification from the whole reconstruction image, the system can derive quality characteristics of a battery from a segmentation of the reconstruction image of the battery. The quality characteristics can include linear distances between structures, areas, volumes, the presence of inclusions or voids in the battery.

In some implementations, the systems and techniques described herein are applicable to spherically symmetric objects. In some implementations, the at least one object or the portion of the at least one object can be spherically symmetric. The at least one object can be a ball having one or more layers, and the providing (208) can include inspecting the one or more layers of the ball using the reconstruction image. FIG. 6A shows an example of a radiograph of a golf ball. FIG. 6B shows an example of a reconstruction image of the golf ball. The reconstruction image of the golf ball is an accurate representation of the edge locations of the layers 602 and 604 of the golf ball.

In some implementations, the at least one object can be an optical element or an optical assembly, and the providing (208) can include inspecting the optical element or the optical assembly using the reconstruction image. FIG. 4A shows an example of a radiograph of an optical assembly. FIG. 4B shows an example of a reconstruction image of the optical assembly. Various parts of the optical assembly share the same axis of symmetry, the system can generate the reconstruction image in FIG. 4B (e.g., an approximate CT slice) from a single radiograph of the optical assembly. The system can generate an inspection result for the optical assembly based on the reconstruction image in FIG. 4B.

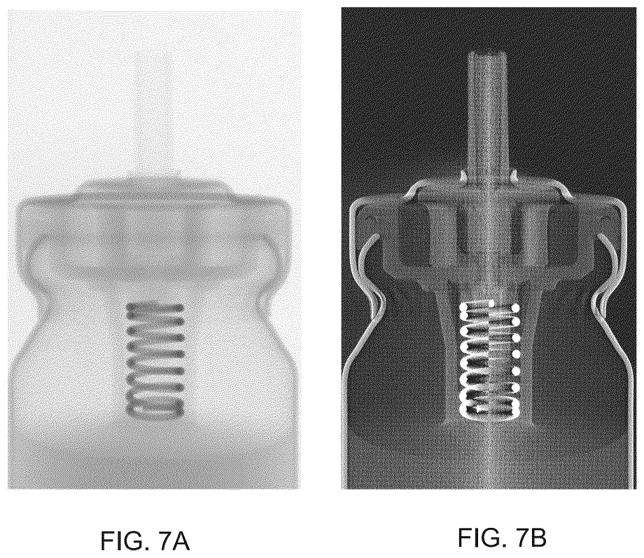

In some implementations, the at least one object can include a medical device, and the providing (208) can include inspecting the medical device using the reconstruction image. FIG. 7A shows an example of a radiograph of an inhaler. FIG. 7B shows an example of a reconstruction image of the inhaler. The system can generate an inspection result for the inhaler based on the reconstruction image in FIG. 7B.

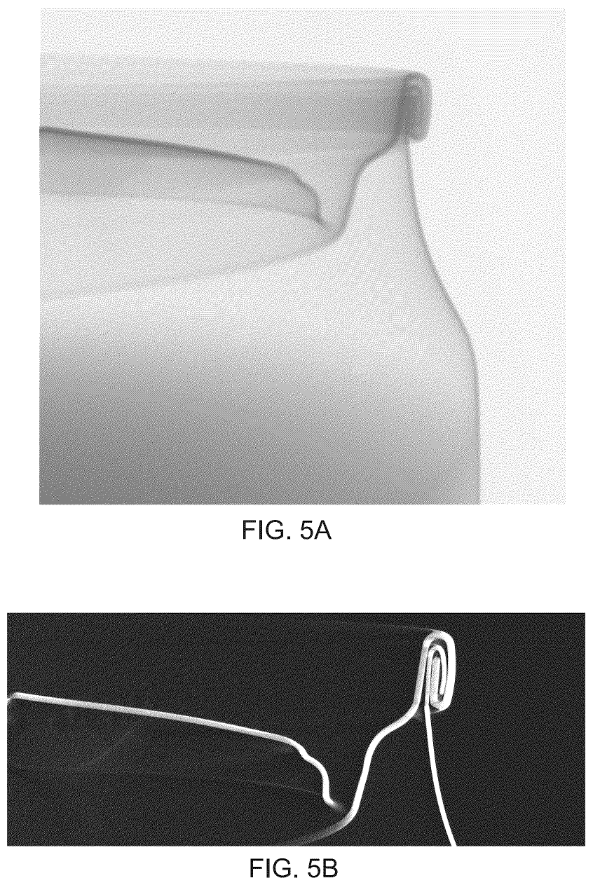

In some implementations, the at least one object can include a seal, a crimp, or a weld, and the providing (208) can include inspecting the seal, the crimp, or the weld using the reconstruction image. FIG. 5A shows an example of a radiograph of a can. FIG. 5B shows an example of a reconstruction image of the can. The system can inspect the folded edge of the can using the reconstruction image. FIG. 10C shows an example of a line-scan radiograph of the lid. FIG. 10D shows an example of a reconstruction image of the lid generated from the line-scan radiograph in FIG. 10C. The system can inspect the seal 1002 of the lid, such as the gap 1004 in the seal 1002.

In some implementations, the system can detect an anomaly of the at least one object using the reconstruction image. For example, the system can detect the bent electrode 302 in the battery cell using the reconstruction image in FIG. 3B. In some implementations, the system can perform wall thickness analysis of a wall of the at least one object using the reconstruction image. For example, the system can perform wall thickness analysis of the wall 318 of the battery using the reconstruction image in FIG. 3B. In some implementations, the system can perform circularity analysis of the portion of the at least one object using the reconstruction image. For example, the system can perform circularity analysis of the battery using the reconstruction image in FIG. 3B. As another example, the system can perform circularity analysis of the golf ball using the reconstruction image in FIG. 6B. In some implementations, the system can extract a dimensional measurement (e.g., linear, radial, angular, or location) of the portion of the at least one object using the reconstruction image. For example, the system can measure the volume or the surface area of the golf ball using the reconstruction image in FIG. 6B.

In some implementations, the inspection result can be based on an acquisition geometry of the X-ray scanner and a known location and a known orientation of the at least one object in the X-ray scanner. In some implementations the inspection result can be based on prior knowledge of the expected materials and expected structure in the object to identify anomalies. For example, the system can generate an inspection result of a battery that includes unexpected histogram, blurry anodes, etc.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as a hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media, and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter.

Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desired results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims.

What is claimed is:

1. A method comprising:
obtaining a radiograph of at least one object using an X-ray scanner, wherein the at least one object has been manufactured using a manufacturing process;
determining an axis of symmetry for at least a portion of the at least one object that is axisymmetric based on a type of the at least one object;
generating a reconstruction image for the at least one object by applying an inverse Abel transform on the radiograph using the axis of symmetry; and
providing an inspection result for the at least one object by processing the reconstruction image based on the type of the at least one object, wherein the inspection result causes a subsequent step of the manufacturing process to be performed based on the inspection result.

2. The method of claim 1, wherein determining the axis of symmetry comprises using projected intensity changes in the radiograph to perform a parameter fitting calculation to predict the axis of symmetry.

3. The method of claim 1, comprising determining that at least the portion of the at least one object is substantially axisymmetric, comprising:
calculating an axisymmetric error in the at least one object using a similarity metric;
determining whether the axisymmetric error is less than a threshold value; and
in response to determining that the axisymmetric error is less than the threshold value, determining that at least the portion of the at least one object is substantially axisymmetric.

4. The method of claim 3, wherein the similarity metric is based on a magnitude of a gradient of a two-dimensional slice with respect to an angular coordinate of a polar coordinate system, the two-dimensional slice is a cross section of the at least the portion of the at least one object, and the two-dimensional slice is represented in the polar coordinate system.

5. The method of claim 3, wherein the at least one object or the portion of the at least one object is elliptically symmetric along a major axis and a minor axis, and the method comprising:
generating a scaled object by scaling the at least one object along the major axis or the minor axis such that after the scaling, the at least one object or the portion of the at least one object has the same size along the major axis and the minor axis; and
determining that the scaled object is substantially axisymmetric.

6. The method of claim 1, comprising determining that at least the portion of the at least one object is substantially axisymmetric, comprising:
measuring, using a similarity metric, a degree of symmetry among slices of the at least the portion of the at least one object sampled across the axis of symmetry, wherein the slices are sampled using an angular step size determined based on a size of a feature of interest in the at least the portion of the at least one object;
determining whether the degree of symmetry satisfies a threshold value; and
in response to determining that the degree of symmetry satisfies the threshold value, determining that at least the portion of the at least one object is substantially axisymmetric.

7. The method of claim 1, wherein determining the axis of symmetry comprises using geometry information of the at least one object to predict the axis of symmetry.

8. The method of claim 1, wherein the at least the portion of the at least one object comprises a first portion of the at least one object, the determining comprises determining a first axis of symmetry for the first portion and determining a second axis of symmetry for a second portion of the at least one object, the second axis of symmetry being different than the first axis of symmetry, and the generating comprises applying the inverse Abel transform to a first cropped portion of the radiograph using the first axis of symmetry and applying the inverse Abel transform to a second cropped portion of the radiograph using the second axis of symmetry.

9. The method of claim 8, wherein the at least one object is a first object and a second object, which are not connected with each other in the radiograph, the first portion is in the first object, and the second portion is in the second object.

10. The method of claim 8, wherein the determining for the first axis and the determining for the second axis are performed in parallel or concurrently.

11. The method of claim 1, wherein an X-ray source of the X-ray scanner generates a cone-shaped or a fan-shaped X-ray beam, and the obtaining comprises:
translating the at least one object to a predetermined number of locations through a center plane, wherein the predetermined number is greater than one, wherein the center plane is a plane that is orthogonal to the axis of symmetry and intersects the X-ray source of the X-ray scanner;
producing the predetermined number of candidate radiographs of the at least one object at the predetermined number of locations;
extracting one or more rows of projection data from each candidate radiograph of the predetermined number of candidate radiographs, wherein X-rays of the X-ray source that generated the one or more rows of the projection data are orthogonal to the axis of symmetry; and
obtaining the radiograph of the at least one object by combining the one or more rows of the projection data from each candidate radiograph of the predetermined number of candidate radiographs, wherein the radiograph is a single radiograph that would have been obtained if all X-rays of the X-ray source were orthogonal to the axis of symmetry.

12. The method of claim 1, wherein an X-ray source of the X-ray scanner generates a cone-shaped or a fan-shaped X-ray beam, and the obtaining comprises:
acquiring an initial radiograph of the at least one object using the X-ray scanner; and
obtaining the radiograph of the at least one object by applying a scale factor to each pixel in the initial radiograph, wherein the scale factor for each pixel in the initial radiograph is a function of both a distance from the pixel on a detector of the X-ray scanner to the axis of symmetry and a source-to-detector distance.

13. The method of claim 1, wherein the at least one object comprises threads, and the threads are parallel with X-rays of the X-ray scanner that intersects with the threads.

14. The method of claim 1, wherein X-rays of the X-ray scanner are polychromatic, the radiograph is a beam-hardening-corrected radiograph, and the obtaining comprises performing beam hardening correction on a received radiograph to obtain the beam-hardening-corrected radiograph.

15. The method of claim 1, wherein the generating comprises:
producing an initial reconstruction image by applying the inverse Abel transform on the radiograph using the axis of symmetry; and
applying a denoising filter to the initial reconstruction image to reduce a vertical band of noise along the axis of symmetry and to produce the reconstruction image for the at least one object, wherein a magnitude of the denoising filter at a location is proportional to an inverse square root of a distance from the location to the axis of symmetry.

16. The method of claim 1, wherein the at least one object comprises one or more layers of a material arranged in a spiral shape.

17. The method of claim 1, wherein the at least one object comprises a battery, and the providing comprises inspecting the battery using the reconstruction image to provide the inspection result.

18. The method of claim 17, wherein the inspecting comprises measuring an anode-cathode overhang distance of the battery using the reconstruction image.

19. The method of claim 17, wherein the inspecting comprises measuring a uniformity of layers of the battery using the reconstruction image.

20. The method of claim 17, wherein the inspecting comprises detecting a void within layers of the battery using the reconstruction image.

21. The method of claim 17, wherein the inspecting comprises measuring a thickness of a can wall of the battery using the reconstruction image.

22. The method of claim 17, wherein the inspecting comprises measuring an electrolyte fill level of the battery using the reconstruction image.

23. The method of claim 17, wherein the inspecting comprises:
extracting a feature from the reconstruction image, wherein the feature comprises one or more key points, one or more blobs, or both, generated using an image analysis algorithm; and
generating a dimensional measurement of the battery using the feature extracted from the reconstruction image, wherein the inspection result comprises the dimensional measurement of the battery that indicates a quality of the battery.

24. The method of claim 17, wherein the inspecting comprises:
generating a segmentation for the reconstruction image; and
generating a characteristic of the battery using the segmentation for the reconstruction image, wherein the inspection result comprises the characteristic of the battery that indicates a quality of the battery.

25. The method of claim 24, wherein the characteristic comprises a distance between structures, a measurement of an area or a volume, a presence of an inclusion or a void, or a combination of these.

26. The method of claim 1, wherein the at least one object or the portion of the at least one object is spherically symmetric.

27. The method of claim 26, wherein the at least one object is a ball having one or more layers, and the providing comprises inspecting the one or more layers of the ball using the reconstruction image.

28. The method of claim 1, wherein the at least one object comprises an optical element or an optical assembly, and the providing comprises inspecting the optical element or the optical assembly using the reconstruction image.

29. The method of claim 1, wherein the at least one object comprises a medical device, and the providing comprises inspecting the medical device using the reconstruction image.

30. The method of claim 1, wherein the at least one object comprises a seal, a crimp, or a weld, and the providing comprises inspecting the seal, the crimp, or the weld using the reconstruction image.

31. The method of claim 1, wherein the providing comprises detecting an anomaly of the at least one object using the reconstruction image.

32. The method of claim 1, wherein the providing comprises performing wall thickness analysis of a wall of the at least one object using the reconstruction image.

33. The method of claim 1, wherein the providing comprises performing circularity analysis of the portion of the at least one object using the reconstruction image.

34. The method of claim 1, wherein the providing comprises extracting a dimensional measurement of the portion of the at least one object using the reconstruction image.

35. The method of claim 1, wherein the inspection result is based on an acquisition geometry of the X-ray scanner and a known location and a known orientation of the at least one object in the X-ray scanner.

36. The method of claim 1, wherein the inspection result causing the subsequent step of the manufacturing process to be performed comprises causing a parameter of the manufacturing process to be updated based on the inspection result.

37. The method of claim 36, wherein the inspection result comprises a value of a quality metric of the manufacturing process based on the reconstruction image, the inspection result causes the parameter of the manufacturing process to be updated in order to reduce a deviation of the quality metric from a predetermined value.

38. The method of claim 1, wherein the inspection result causing the subsequent step of the manufacturing process to be performed comprises causing categorizing of the at least one object on a manufacturing line based on the inspection result.

39. The method of claim 1, the generating comprises:
producing an initial reconstruction image for the at least one object by applying the inverse Abel transform on the radiograph using the axis of rotation;
identifying, using a mask for an asymmetric feature of the at least one object, a region in the initial reconstruction image that corresponds to an artifact caused by the asymmetric feature of the at least one object; and
creating the reconstruction image by excluding the region from the initial reconstruction image.

40. A system comprising:
a data processing apparatus including at least one hardware processor; and
a non-transitory computer-readable medium encoding instructions configured to cause the data processing apparatus to perform operations comprising:
obtaining a radiograph of at least one object using an X-ray scanner, wherein the at least one object has been manufactured using a manufacturing process;
determining an axis of symmetry for at least a portion of the at least one object that is axisymmetric based on a type of the at least one object;
generating a reconstruction image for the at least one object by applying an inverse Abel transform on the radiograph using the axis of symmetry; and
providing an inspection result for the at least one object by processing the reconstruction image based on the type of the at least one object, wherein the inspection result causes a subsequent step of the manufacturing process to be performed based on the inspection result.

41. A non-transitory computer-readable medium encoding instructions operable to cause a data processing apparatus to perform operations comprising:
obtaining a radiograph of at least one object using an X-ray scanner, wherein the at least one object has been manufactured using a manufacturing process;
determining an axis of symmetry for at least a portion of the at least one object that is axisymmetric based on a type of the at least one object;
generating a reconstruction image for the at least one object by applying an inverse Abel transform on the radiograph using the axis of symmetry; and
providing an inspection result for the at least one object by processing the reconstruction image based on the type of the at least one object, wherein the inspection result causes a subsequent step of the manufacturing process to be performed based on the inspection result.
